(19) United States
(12) Patent Application Publication
(10) Pub. No.: US 2016/0066295 A1
(43) Pub. Date: Mar. 3, 2016

(54) PROCESSING METHOD OF A COMMUNICATION FUNCTION AND ELECTRONIC DEVICE SUPPORTING THE SAME

(71) Applicant: Samsung Electronics Co., Ltd., Gyeonggi-do (KR)

(72) Inventors: Woo Jung HAN, Seoul (KR); Seung Hwan HONG, Gyeonggi-do (KR); So Ra KIM, Seoul (KR); Seo Young YOON, Seoul (KR)

(21) Appl. No.: 14/838,814

(22) Filed: Aug. 28, 2015

(30) Foreign Application Priority Data
Aug. 29, 2014 (KR) 10-2014-0114105

(51) Int. Cl. H04W 68/00; H04M 1/04; G02B 27/01; G06F 3/01

(52) U.S. Cl. CPC H04W 68/00; G06F 3/013; H04M 1/04; G02B 27/017

(57) ABSTRACT

An electronic device may include a communication interface for receiving a communication event and a processor that is configured to check a connected state or a mounted state of a body-mounted device and to differentially output at least one output interface related to the communication event corresponding to at least one of the connected state and the mounted state.

### CLAIM OF PRIORITY

This application claims the benefit under 35 U.S.C. §119(a) of a Korean patent application filed on Aug. 29, 2014 in the Korean Intellectual Property Office and assigned Serial number 10-2014-0114105, the entire disclosure of which is hereby incorporated by reference.

### BACKGROUND

1. Technical Field

The present disclosure relates to control of a communication function.

2. Description of the Related Art

Existing electronic devices such as smartphones provide screens related to operation of various user functions that appear on displays of the devices.

To ensure that the devices remain portable, the displays of such devices are limited in their size. To overcome the limitation of the size of the display, head-mounted devices have been devised to give a sense of viewing a wide screen.

A head-mounted device may include an insertion area for the reception of an electronic device (e.g., a videogame cartridge) that instructs the head-mounted device in the playback of content. Such electronic devices are considerably limited in operation of other functions besides that of the playback function. Functions that cannot be operated by such electronic devices while the device is mounted and operated in the head-mounted device include, for example, a call function.

### SUMMARY

Accordingly, an aspect of the present disclosure is to provide a communication function control method for smoothly performing a communication function of an electronic device even while a function related to a body-mounted device (e.g., a head-mounted device) is performed, and an electronic device supporting the same.

In accordance with an aspect of the present disclosure, an electronic device is provided. The electronic device includes a communication interface for receiving a communication event and a processor configured to check a connected state or a mounted state of a body-mounted device such as a head-mounted device and differentially output at least one output interface related to the communication event corresponding to the connected state or the mounted state.

In accordance with another aspect of the present disclosure, a communication function control method is provided. The communication function control method includes receiving a communication event, checking a connected state or a mounted state of a body-mounted device, and differentially outputting at least one output interface related to the communication event corresponding to the connected state or the mounted state.

### BRIEF DESCRIPTION OF THE DRAWINGS

FIG. 1 is a perspective view of a body-mounted device operating system according to various embodiments of the present disclosure.

FIG. 2 is a diagram illustrating an electronic device operating system according to various embodiments of the present disclosure.

FIG. 3 is a diagram illustrating a configuration of a function control module according to various embodiments of the present disclosure.

FIG. 4 illustrates a communication function control method according to various embodiments of the present disclosure.

FIG. 5 illustrates a call function ending method according to various embodiments of the present disclosure.

FIG. 6 is a diagram illustrating call function processing in a device-worn state according to various embodiments of the present disclosure.

FIG. 7 illustrates audio control related to call function processing in a device-worn state according to various embodiments of the present disclosure.

FIG. 8 is a diagram illustrating call function processing during disconnection of a device according to various embodiments of the present disclosure.

FIG. 9 is a diagram illustrating call function processing at the time of receiving a call in a state of wearing a device according to various embodiments of the present disclosure.

FIG. 10 is a diagram illustrating call function processing at the time of receiving a communication message according to various embodiments of the present disclosure.

FIG. 11 is a diagram of an example of an electronic device, according to various embodiments of the present disclosure.

FIG. 12 is a block diagram illustrating a program module according to various embodiments of the present disclosure.

### DETAILED DESCRIPTION

Hereinafter, various embodiments of the present disclosure will be described in detail with reference to the accompanying drawings. However, it should be understood that the present disclosure is not limited to specific embodiments, but rather includes various modifications, equivalents and/or alternatives of various embodiments of the present disclosure. Regarding description of the drawings, like reference numerals may refer to like elements.

The terms “have”, “may have”, “include”, “may include” and/or “comprise” as used herein indicate the existence of a corresponding feature (e.g., a number, a function, an operation, or an element) and do not exclude the existence of additional features.

The terms “A or B”, “at least one of A and/or B”, and/or “one or more of A and/or B” may include all possible combinations of items listed together. For example, the terms “A or B”, “at least one of A and B”, and/or “at least one of A or B” may indicate all the cases of (1) including at least one A, (2) including at least one B, and (3) including at least one A and at least one B.

The term “first”, “second” or the like used herein may modify various elements regardless of order and/or priority, but does not limit the elements. Such terms may be used to distinguish one element from another element. For example, “a first user device” and “a second user device” may indicate different user devices regardless of order or priority. For example, without departing the scope of the present disclosure, a first element may be referred to as a second element and vice versa.

It will be understood that when a certain element (e.g., a first element) is referred to as being “operatively or communicatively coupled with/to” or “connected to” another element (e.g., a second element), the certain element may be coupled to the other element directly or via another element (e.g., a third element). However, when a certain element (e.g., a first element) is referred to as being “directly coupled” or “directly connected” to another element (e.g., a second element), there may be no intervening element (e.g., a third element) between the element and the other element.

The term “configured (or set) to” may be interchangeably used with the term, for example, “suitable for”, “having the capacity to”, “designed to”, “adapted to”, “made to”, or “capable of”. The term “configured (or set) to” may not necessarily have the meaning of “specifically designed to”. In some cases, the term “device configured to” may indicate that the device “may perform” together with other devices or components. For example, the term “processor configured (or set) to perform A, B, and C” may represent a dedicated processor (e.g., an embedded processor) for performing a corresponding operation, or a generic-purpose processor (e.g., a CPU or an application processor) for executing at least one software program stored in a memory device to perform a corresponding operation.

The terminology used herein is not for delimiting the present disclosure but for describing specific various embodiments. The terms of a singular form may include plural forms unless otherwise specified. The terms used herein, including technical or scientific terms, have the same meanings as understood by those skilled in the art. Commonly used terms defined in a dictionary may be interpreted as having meanings that are the same as or similar to contextual meanings defined in the related art, and should not be interpreted in an idealized or overly formal sense unless otherwise defined explicitly. Depending on a particular case, even the terms defined herein should not be such interpreted as to exclude various embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device (e.g., smartglasses, a head-mounted device (HMD), an electronic apparel, an electronic bracelet, an electronic necklace, an electronic appcessory, an electronic tattoo, a smart mirror, or a smartwatch).

In some various embodiments of the present disclosure, an electronic device may be a smart home appliance. The smart home appliance may include at least one of, for example, a television (TV), a digital versatile disc (DVD) player, an audio, a refrigerator, an air conditioner, a cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, or an electronic picture frame.

In other various embodiments of the present disclosure, an electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA), a magnetic resonance imaging (MRI), a computed tomography (CT), a scanner, an ultrasonic device, or the like), a navigation device, a global positioning system (GPS) receiver, an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automatic teller's machine (ATM), a point of sales (POS) of a store, or an Internet of things device (e.g., a bulb, various sensors, an electric or gas meter, a sprinkler, a fire alarm, a thermostat, a streetlamp, a toaster, exercise equipment, a hot water tank, a heater, a boiler, or the like).

According to some various embodiments of the present disclosure, an electronic device may include at least one of a part of furniture or a building/structure, an electronic board, an electronic signature receiving device, a projector, or a measuring instrument (e.g., a water meter, an electricity meter, a gas meter, a wave meter, or the like). In various embodiments of the present disclosure, an electronic device may be one or more combinations of the above-mentioned devices. An electronic device according to some various embodiments of the present disclosure may be a flexible device. An electronic device according to an embodiment of the present disclosure is not limited to the above-mentioned devices, and may include new electronic devices with the development of technology.

Hereinafter, an electronic device according to various embodiments of the present disclosure will be described with reference to the accompanying drawings. The term “user” used herein may refer to a person who uses an electronic device or may refer to a device (e.g., an artificial electronic device) that uses an electronic device.

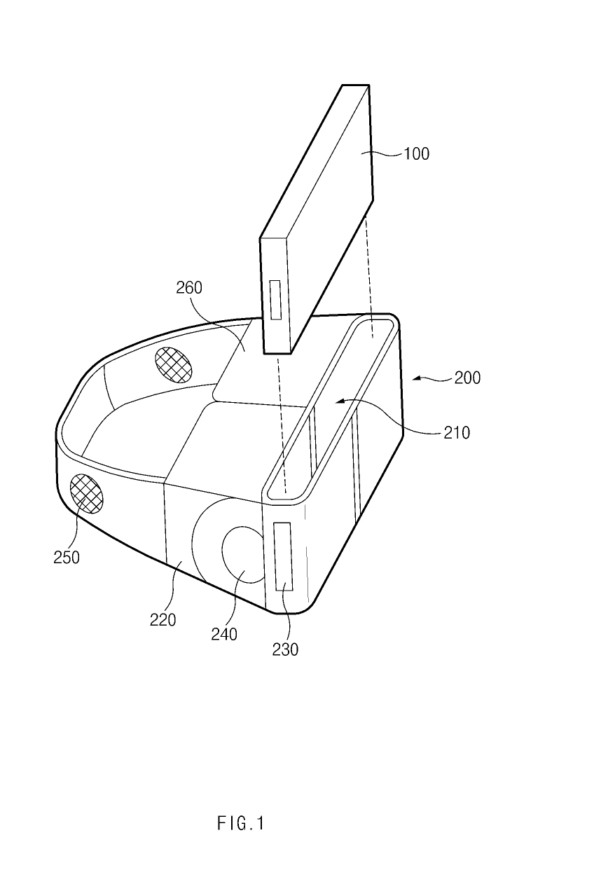

FIG. 1 is a perspective view of a body-mounted device operating system according to various embodiments of the present disclosure.

Referring to FIG. 1, the body-mounted device operating system may include an electronic device 100 and a body-mounted device, for example, a head-mounted device 200.

In the body-mounted device operating system, the electronic device 100 may be mounted on the head-mounted device 200 to play virtual reality content. Accordingly, a user may view content through the head-mounted device 200. For example, the electronic device 100 may display virtual content for the head-mounted device 200 on each of separated display areas of a display (e.g., the display may include a display area for each of the user's eyes). The electronic device 100 may cause the display of virtual content on a display, which may include the separate display areas, depending on how the electronic device is mounted to the head-mounted device 200. For example, when the electronic device 100 is mounted to the head-mounted device 200 content may be displayed on a display area of the display. Content may also or alternatively be displayed when the electronic device 100 is being released or dismounted from the head-mounted device 200.

According to various embodiments, content may be displayed in response to either mounting or dismounting of the electronic device 100 to the head-mounted device 200. In an embodiment of the present disclosure, the electronic device 100 may cause the display virtual content on the separated display areas of the display even if the electronic device 100 is released from the head-mounted device 200. Alternatively, according to an embodiment of the present disclosure, the electronic device 100 may prepare virtual content though background processing, and, when being mounted on the head-mounted device 200, the electronic device 100 may cause the display the virtual content on each separated display area of the display.

The way in which the electronic device 100 processes a received communication event (e.g., an event due to reception of a call, text message, instant message, or electronic mail) may correspond to the connection state of the electronic device 100 with respect to the head-mounted device 200. For example, the connection states may include a state of being connected to the head-mounted device 200, a state in which the head-mounted device is worn, or a state of being separated (or disconnected) from the head-mounted device 200. For example, the electronic device 100 may differently provide a call receiving user interface (UI) (or a communication message receiving UI) for the state of being disconnected from the head-mounted device 200 and a call receiving UI (or a communication message receiving UI) for the state of being connected to the head-mounted device 200. Furthermore, the electronic device 100 may differently provide a call receiving notification for the state in which the head-mounted device 200 is worn and a call receiving notification for a state in which the head-mounted device 200 is not worn.

The head-mounted device 200 may include, at one side thereof, a slot 210 to or from which the electronic device 100 is inserted or removed (or mounted or dismounted), an observation part 260, and a mounting part 220 for mounting the head-mounted device on a certain portion of a body of the user. The head-mounted device 200 may further include a sensor module 230, a key input device 240, and/or an input/output device 250.

The slot 210 may have a structure to or from which the electronic device 100 is configured to be inserted or ejected. The slot 210 may have a size that approximates that of the electronic device 100. One side of the slot 210 may be formed such that an output interface of the electronic device 100, for example, a display 150, may be exposed towards eyes of the user wearing the head-mounted device 200. According to various embodiments of the present disclosure, a vertical boundary part may be disposed at a center of the slot 210. In various embodiments of the present disclosure, the slot 210 may be replaced with a side open type slot or a front open type slot. In this case, the electronic device 100 may be inserted into a side surface or a front surface of the head-mounted device 200.

The observation part 260 may be connected to the slot 210 so as to support magnified viewing of the display 150 of the electronic device 100. To this end, the observation part 260 may include at least one physical lens or digital lens. At least two units of the observation part 260 may be arranged adjacent to each other so as to support binocular viewing of the user.

One side of the mounting part 220 may be connected to a certain area of the slot 210 or a side of the observation part 260. The mounting part 220, for example, may be disposed so as to surround a head of the user. At least a part of the mounting part 220, for example, may include an elastic member (not shown).

The sensor module 230 may sense a movement of the head-mounted device 200. The sensor module 230 may include at least one of various sensors such as an acceleration sensor, a gyro sensor, a geomagnetic sensor, an illumination sensor, or the like. Sensing information collected by the sensor module 230 may be provided to the electronic device 100. For example, the sensor module 230 may collect sensing information related to a state of being worn by a part of the body of the user, and may provide the collected sensing information to the electronic device 100. The sensing information collected by the sensor module 230 may include a movement (e.g., a vertical or horizontal movement) of the head-mounted device 200, and may provide the collected sensing information to the electronic device 100.

The sensor module 230 may be automatically activated when the electronic device 100 is inserted into the slot 210. The sensor module 230 may be automatically deactivated when the electronic device 100 is ejected from the slot 210. According to various embodiments of the present disclosure, the sensor module 230 may include an image sensor for detecting a gaze of the user. The sensor module 230 may collect information, including for example, a change in a gaze of a user, and may transfer the information to the electronic device 100.

According to various embodiments of the present disclosure, the sensor module 230 may include a proximity sensor that collects proximity sensing information corresponding to a state in which the head-mount device 200 is mounted or dismounted. The proximity sensor included in the sensor module 230 may be disposed in at least one of the mounting part 220 and the observation part 260. For example, the proximity sensor may be disposed at such a portion of the observation part 260 that the proximity sensor may sense approach of a face of the user.

The key input device 240 may include at least one of a keypad (or a touchpad) or a physical button. The key input device 240 may include, for example, a function button related to turning on/off of the head-mounted device 200. According to various embodiments of the present disclosure, the key input device 240 may include a function button related to accepting or rejecting an incoming call, a function button related to ending a call, or the like. According to various embodiments of the present disclosure, the key input device 240 may include a function button for voice (or video) recording of a call. Although shown as being circular in FIG. 1, the key input device 240 may be configured to have a different shape including, for example, a quadrangle shape, a triangle shape, a star shape, an arrow shape, or the like. An input event corresponding to selection of the key input device 240 may be transferred or transmitted to the electronic device 100.

The input/output device 250 may include at least one of an audio module, a vibration module, or a lamp module. The input/output device 250 may increase a volume of audio data provided by the electronic device 100 or may add a specified sound effect to the audio data to output the audio data. According to an embodiment of the present disclosure, the audio module that may be included in the input/output device 250 may receive, from the electronic device 100, audio data corresponding to reception of a call and may output the received audio data. According to an embodiment of the present disclosure, the audio module may receive, from the electronic device 100, audio data related to virtual content (e.g., content related to the head-mounted device 200), and may output the received audio data. According to various embodiments of the present disclosure, the input/output device 250 may generate a vibration or turn on a lamp based on vibration pattern information or lamp on/off information provided by the electronic device 100. The input/output device 250 may be activated or deactivated corresponding to whether the electronic device 100 is inserted into the head-mounted device 200.

Upon receiving the communication event, the electronic device 100 may perform differentiated operations corresponding to at least one of a state of connection to the head-mounted device 100 or a state of wearing the head-mounted device 200. According to an embodiment of the present disclosure, if the electronic device 100 is mounted in the head-mounted device 200, the electronic device 100 may detect whether it has been mounted to the head-mounted device 200. As the electronic device 100 detects that it is mounted in the head-mounted device 200, the electronic device 100 may support output of virtual content (e.g., a home screen or a standby screen corresponding to the head-mounted device 200, or content to be played in relation to the head-mounted device 200).

Alternatively, the electronic device 100 may be mounted in the head-mounted device 200 while virtual content is being output. When the electronic device 100 receives a communication event (e.g., a call or a message) while outputting the virtual content, the electronic device 100 may output a communication event output interface or a communication UI (e.g., a call receiving UI or a message receiving UI) corresponding to a virtual content output environment.

According to various embodiments of the present disclosure, the electronic device 100 may temporarily suspend output of audio related to virtual content, and may output audio corresponding to a notification of reception of the communication event (e.g., notification of reception of a call or a message). Furthermore, if an event corresponding to a call connection request occurs, the electronic device 100 may perform call connection and calling tone sound processing. According to various embodiments of the present disclosure, a call received by the electronic device 100 may include a video call.

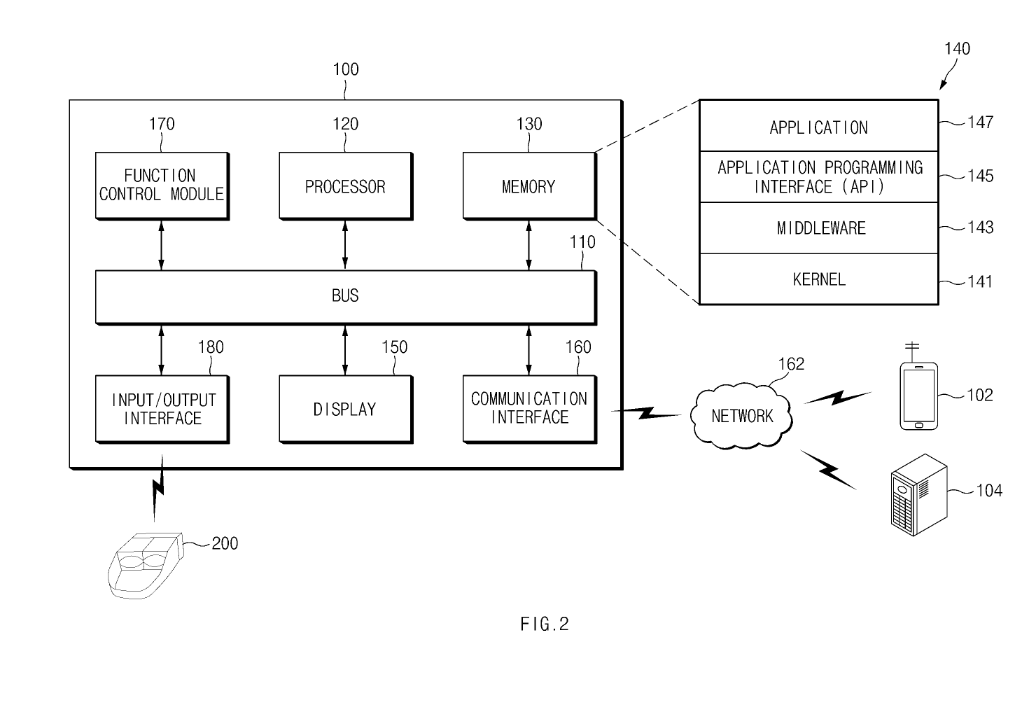

FIG. 2 is a diagram illustrating an electronic device operating system according to various embodiments of the present disclosure.

Referring to FIG. 2, the electronic device operating system may include the electronic device 100, the head-mounted device 200, a network 162, another electronic device 102, and a server device 104.

The network 162 may include at least one of telecommunications networks, for example, a computer network (e.g., a LAN or WAN), the Internet, or a telephone network. The network 162 may support establishment of a communication channel related to operation of a communication service of the electronic device 100. The electronic device 100 may establish a voice call channel or a video call channel to the other electronic device 102 via the network 162. According to an embodiment of the present disclosure, the electronic device 100 may receive a communication event (a voice call connection request, a video call connection request, or a communication message) transmitted from the other electronic device 102 while it is mounted to the head-mounted device 200.

The type of the other electronic device 102 may be the same as or different from that of the electronic device 100. The other electronic device 102 may transmit a (voice or video) call connection request message to the electronic device 100 via the network 162 or may establish a communication channel for requesting message transmission. According to various embodiments of the present disclosure, the other electronic device 102 may transmit the call connection request message to the electronic device 100 while being mounted to the head-mounted device 200. The other electronic device 102 may perform call connection and call function support with respect to the electronic device 100 while being mounted to the head-mounted device 200.

The server device 104 may include a group of one or more servers. According to various embodiments of the present disclosure, a portion or all of operations performed in the electronic device 100 may be performed in one or more other electronic devices (e.g., the electronic device 102 or the server device 104). The server device 104 may establish a communication channel with the electronic device 100 or the other electronic device 104 in relation to support of a communication service.

According to an embodiment of the present disclosure, in the case where the electronic device 100 should perform a certain function or service automatically or in response to a request that the electronic device 100 perform the function, the electronic device 100 may request another device (e.g., the other electronic device 102 or the server device 104) to perform at least a portion of functions related to the function or service instead of or in addition to performing the function or service for itself. The other electronic device (e.g., the other electronic device 102 or the server device 104) may perform the requested function or additional function, and may transfer a result of the performance to the electronic device 100. The electronic device 100 may use or additionally process the received result to provide the requested function or service. To this end, for example, a cloud computing technology, a distributed computing technology, or a client-server computing technology may be used.

The head-mounted device 200 may include a slot into which the electronic device 100 may be inserted, and may also support magnifying (or reducing) and viewing of content displayed on the display 150 of the electronic device 100. The head-mount device 200 may support notification of reception of a call of the electronic device 100. Furthermore, the head-mount device 200 may support processing of a calling tone sound of the electronic device 100. To this end, the head-mounted device 200 may include an output device as described above.

The electronic device 100 may include a bus 110, a processor 120, a memory 130, an input/output interface 180, the display 150, a communication interface 160, and a function control module 170 (or replaceable by a processor). In some various embodiments of the present disclosure, at least one of the foregoing elements may be omitted or another element may be added to the electronic device 100.

The bus 120 of the electronic device 100 may include a circuit for connecting the above-mentioned elements 120 to 170 to each other and transferring communications (e.g., control messages and/or data) among the above-mentioned elements. For example, the bus 110 may transfer an input event related to executing a user function to at least one of the function control module 170 or the processor 120. According to an embodiment of the present disclosure, the bus 110 may transfer an input event related to selection of virtual content in relation to the head-mounted device 200 to the function control module 170. The bus 110 may transfer image data related to playback of the virtual content corresponding to control by the function control module 170 to the display 150. According to various embodiments of the present disclosure, the bus 110 may transfer, to the function control module 170, a communication event (e.g., a call connection request message, a text or instant message, or the like) received through the communication interface 160, and may transfer call reception notifying information to at least one of the input/output interface 180 or the display 150 corresponding to control by the function control module 170.

The processor 120 may include at least one of an application processor (AP), a communication processor (CP), or a central processing unit (CPU). The processor 120 may perform data processing or computation for communication and/or control of at least one of the other elements of the electronic device 100. According to various embodiments of the present disclosure, the processor 120 may perform data processing or control signal processing related to execution of at least one application. According to an embodiment of the present disclosure, the processor 120 may perform computation processing related to operation of the program module 140 loaded on the memory 130. For example, the processor 120 may support computation related to playback of virtual content, processing related to receiving a communication event during playback of virtual content, call connection in response to a call connection request, or the like.

The memory device 130 may include a volatile memory and/or a nonvolatile memory. The memory 130 may store an instruction or data related to at least one of the other elements of the electronic device 100. The memory 130 may store software and/or a program. The program may include, for example, a kernel 141, a middleware 143, an application programming interface (API) 145, and/or an application program (or an application) 147. At least a portion of the kernel 141, the middleware 143, or the API 145 may be referred to as an operating system (OS). According to various embodiments of the present disclosure, the memory 130 may store content (or virtual content or VR content) related to at least one head-mounted device 200. According to various embodiments of the present disclosure, the memory 130 may receive virtual content from the server device 104 through the communication interface 160, and may store the received virtual content in the memory 130 or output the received virtual content to the display 150. Furthermore, the memory 130 may store a received message (e.g., a text message, a multimedia message, an instant message, an electronic mail, or the like).

The kernel 141 may control or manage system resources (e.g., the bus 110, the processor 120, the memory 130, or the like) used to perform operations or functions of other programs (e.g., the middleware 143, the API 145, or the application program 147). Furthermore, the kernel 141 may provide an interface for allowing the middleware 143, the API 145, or the application program 147 to access individual elements of the electronic device 100 so as to control or manage the system resources. According to an embodiment of the present disclosure, the kernel 141 may support a connection interface and connection processing between the electronic device 100 and the head-mounted device 200.

The middleware 143 may function as an intermediary between the API 145 or between the application program 147 and the kernel 141 such that the API 145 or the application program 147 may communicate and exchange data with the kernel 141. Furthermore, the middleware 143 may perform a control operation (e.g., scheduling or load balancing) with respect to operation requests received from the application 147 by using, for example, a method of assigning a priority for using system resources (e.g., the bus 110, the processor 120, the memory 130, or the like) of the electronic device 100 to at least one application of the application program 147. For example, the middleware 143 may set a high priority on reception of a communication event during operation on virtual content. The middleware 143 may be configured to return to a virtual content operation state when a call is ended, or message checking is completed or cancelled.

The API 145, which is an interface for allowing the application program 147 to control a function provided by the kernel 141 or the middleware 143, may include at least one interface or function (e.g., an instruction) for file control, window control, image processing, character control, or the like. According to an embodiment of the present disclosure, the API 145 may include an API for supporting connection of the head-mounted device 200, an API for supporting virtual content operated in the head-mounted device 200, or an API for processing a communication event.

The input/output interface 180 may serve to transfer an instruction or data input from a user or another external device to one or more other elements of the electronic device 100. Furthermore, the input/output interface 180 may output an instruction or data received from the one or more other elements of the electronic device 100 to the user or another external device.

According to an embodiment of the present disclosure, the input/output interface 180 may include an audio processing module. The audio processing module may output audio data related to operation of the electronic device 100. The audio processing module may collect audio data. According to various embodiments of the present disclosure, the audio processing module included in the input/output interface 180 may output audio data contained in virtual content. Furthermore, the audio processing module may output a communication event reception notification. Furthermore, the audio processing module may support collection and output of audio data corresponding to call connection. If a call connection request message is received during playback of virtual content, the audio processing module may output audio data corresponding to a call reception notification. According to various embodiments of the present disclosure, the audio processing module may transfer audio data related to a call and audio data related to virtual content to the head-mounted device 200. Furthermore, in the case where the head-mounted device 200 is equipped with a microphone, the audio processing module may receive audio data collected by the head-mounted device 200 and may process the received audio data.

According to various embodiments of the present disclosure, the input/output interface 180 may further include a vibration module or a lamp module. The vibration module or the lamp module may vibrate or may emit flickering light in a specified pattern in relation to playback of virtual content. Furthermore, the vibration module or the lamp module may vibrate or may emit a flickering light in a specified pattern corresponding to a call reception notification.

The display 150 may include, for example, a liquid crystal display (LCD), a light-emitting diode (LED) display, an organic light-emitting diode (OLED) display, a microelectromechanical systems (MEMS) display, or an electronic paper display. The display 150 may show various content (e.g., a text, an image, a video, an icon, a symbol, or the like) to the user. The display 150 may include a touchscreen, and may receive a touch, a gesture input, a proximity input or a hovering input from an electronic pen or a part of a body of the user.

According to various embodiments of the present disclosure, the display 150 may perform output of virtual content related to operation of the head-mounted device 200. For example, the display 150 may divide a display area into two display areas (in consideration of the binocular head-mounted device 200), and may output data corresponding to playback of content to each display area, image.

According to various embodiments of the present disclosure, the display 150 may output a communication UI (e.g., a call-related UI (e.g., a call reception notification image, a call reception UI, a during-a-call UI, or the like), a message reception UI, or the like) corresponding to a state in which the electronic device 100 is mounted in the head-mounted device 200 or a state of wearing the head-mounted device 200 by the user. The communication UI related to the head-mounted device 200 may include a communication event reception notification image displayed on the two display areas of the display 150, an indicator image (e.g., a button image or the like) related to an input for accepting or rejecting a call, a specified image (e.g., an image displayed on each of the two display areas of the display 150) corresponding to call connection, a screen related to displaying of a message, or the like. According to various embodiments of the present disclosure, the communication UI may include an image displayed on each of the two display areas of the display 150 in response to a video call. A touch panel of the display 150 may be deactivated when the device 100 is connected or mounted to the head-mounted device 200.

According to various embodiments of the present disclosure, the display 150 may output a screen in response to a communication event reception as one image if there is no connection to the head-mounted device 200 (disconnected state) or if the head-mounted device 200 is not mounted (i.e., is in a dismounted state). Furthermore, the display 150 may output a virtual key button related to accepting or rejecting a call in the disconnected state or dismounted state. The display 150 may activate the touch panel in relation to operation of the virtual key button.

The communication interface 160 may set up communications between the electronic device 100 and an external electronic device (e.g., the other electronic device 102 or the server device 104). For example, the communication interface 160 may be connected to the network 162 wirelessly or by wire so as to communicate with the external electronic device (e.g., the other electronic device 102 or the server device 104). For example, at least one of cellular communication protocols such as LTE, LTE-A, CDMA, WCDMA, UMTS, WiBro, GSM, or the like may be used for the wireless communication. A technology for the wired communication may include at least one of universal serial bus (USB), high definition multimedia interface (HDMI), recommended standard 232 (RS-232), plain old telephone service (POTS), or the like. Short-range wireless communication may be performed using a communication method based on a Bluetooth communication module, a Wi-Fi direct communication module, or the like. According to various embodiments of the present disclosure, a wired communication interface included in the communication interface 160, such as USB, HDMI, or the like, may be used as a part for electrical connection to the head-mounted device 200.

According to various embodiments of the present disclosure, the communication interface 160 may establish a communication channel to the head-mounted device 200 via a Bluetooth communication module or a Wi-Fi direct communication module.

The communication interface 160 may receive a call connection request message from the other electronic device 102. The communication interface 160 may transmit, to the other electronic device 102, a call connection acceptance message in response to control by the user. The communication interface 160 may establish a voice call channel or a video call channel to the other electronic device 102.

The function control module 170 may include at least one processor. Alternatively, the function control module 170 may be at least a part of a processor. The function control module 170 may support connection to the head-mounted device 200 and a call-related function of the electronic device 100. For example, the function control module 170 may support output of a home screen or a standby screen related to the head-mounted device 200 in response to a user input. The home screen or the standby screen related to the head-mounted device 200 may be a screen in which identical images are displayed on the two display areas of the display 150. According to various embodiments of the present disclosure, the function control module 170 may support a virtual content search function. When a request to play virtual content is made, the function control module 170 may perform image control corresponding to playback of content. The way in which the function control module 170 may process a communication event correspond to a state of being connected to or disconnected from the head-mounted device 200 or a mounted state or a dismounted state of the head-mounted device 200. For example, the function control module 170 may support processing of a communication event with the head-mounted device 200 in response to the state of being connected or mounted to the head-mounted device 200.

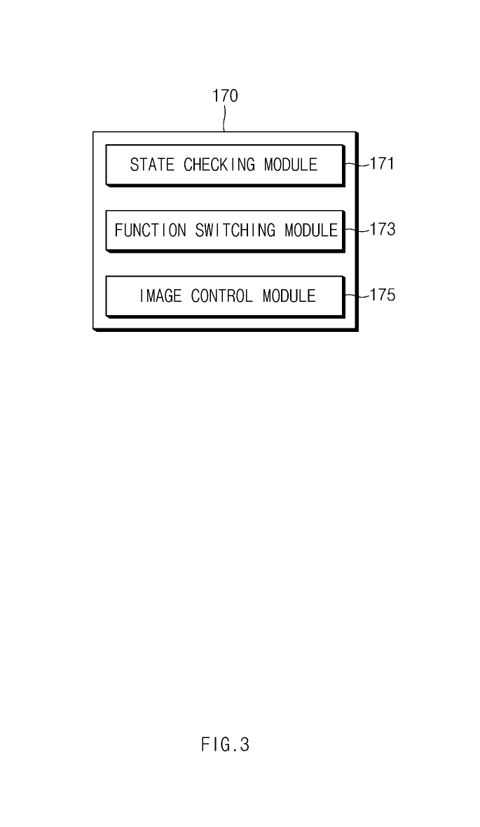

FIG. 3 is a diagram illustrating a configuration of a function control module according to various embodiments of the present disclosure.

Referring to FIG. 3, the function control module 170 may include a state checking module 171, a function switching module 173, and/or an image control module 175.

The state checking module 171 may collect state information of the electronic device 100. For example, the state checking module 171 may collect information on a state of connection between the electronic device 100 and the head-mounted device 200. The state checking module 171 may collect information on a state in which the head-mounted device 200 is mounted, while being connected to the head-mounted device 200. For example, the state checking module 171 may receive sensing information related to device mounting from the head-mounted device 200, and may check a mounted state of the head-mounted device 200. The state checking module 171 may transfer the state information of the electronic device 100 to at least one of the function switching module 173, the image control module 175, and/or the function control module 170.

The function switching module 173 may support function processing or function switching of the electronic device 100. For example, the function control module 173 may provide a virtual content output related to the head-mounted device 200 in response to occurrence of an input event. The function switching module 173 may perform control so that virtual content specified by the input event is executed in virtual content (e.g., a home screen, a virtual content list screen, or the like). If the function switching module 173 receives a communication event (e.g., a call connection request message or a text message) while outputting (or playing) virtual content, the function switching module 173 may temporarily suspend playback of virtual content and may support output of a call-related UI or processing of a call. Alternatively, the function switching module 173 may output a communication UI onto virtual content (e.g., a home screen or the like) related to the head-mounted device 200.

The function switching module 173 may support a call connection function in response to a call connection request being made, and may resume playback of virtual content when a call is ended. In the above-mentioned operation, the function switching module 173 may request the image control module 175 to output virtual content related to the head-mounted device 200 and a communication event-related UI.

According to various embodiments of the present disclosure, if the electronic device 100 is connected to the head-mounted device 200 in a state where a communication event (e.g., a call) has been received, the function switching module 173 may request the image control module 175 to switch an output of a communication UI related to the head-mounted device 200. Furthermore, if the electronic device 100 is disconnected from the head-mounted device 200 in a state where a communication event has been received, the function switching module 173 may request the image control module 175 to switch an output of a communication UI related to the electronic device 100.

According to various embodiments of the present disclosure, the function switching module 173 may perform audio path switching related to operation of the head-mounted device 200. For example, the function switching module 173 may receive a call connection request message while outputting audio data corresponding to playback of virtual content. In this case, the function switching module 173 may temporarily suspend output of the audio data corresponding to the playback of the virtual data, and may control output of audio data related to reception of the call connection request message.

According to various embodiments of the present disclosure, the function switching module 173 may suspend output of audio data related to a call if a call function, which is performed while the head-mounted device 200 is mounted, is ended. Furthermore, the function switching module 173 may resume the output of the audio data corresponding to the playback of the virtual content as a call is ended. According to various embodiments of the present disclosure, the function switching module 173 may output audio data related to a call reception notification if the electronic device 100 is connected to the head-mounted device 200 but the head-mounted device 200 is not mounted. The function switching module 173 may skip output of the audio data related to the call reception notification if the head-mounted device 200 to which the electronic device 100 is connected is mounted. In this operation, the function switching module 173 may notify reception of a call with a patterned vibration or flickering lamp light.

When a call is connected, the function switching module 173 may perform audio path switching (i.e., suspend output of audio data corresponding to playback of virtual content, and performing a function of outputting or collecting audio data related to a call). In the case where the head-mounted device 200 includes the input/output device 250 (at least one of a microphone or a speaker), the function switching module 173 may transfer audio data corresponding to playback of virtual content to the input/output device 250 of the head-mounted device 200. Furthermore, when performing a call connection function, the function switching module 173 may request the head-mounted device 200 to activate the microphone of the head-mounted device 200.

The image control module 175 may control output of a screen corresponding to execution of a function of the electronic device 100. For example, the image control module 175 may output a virtual content search screen (e.g., a list screen, a standby screen, or a home screen related to virtual content). The list screen, the standby screen, or the home screen related to virtual content may be displayed on a display area of the display 150, which may include a plurality of display areas. The content may be displayed on each of the display areas of the display 150. When playback of specified virtual content is requested, the image control module 175 may divide the display area of the display 150 so that the display 150 is adapted for the head-mounted device 200. Alternatively, the image control module 175 may output a playback screen of virtual content to one display area of the display 150, and then may individually output the screen to separated display areas when the head-mounted device 200 is connected.

According to an embodiment of the present disclosure, the image control module 175 may individually display identical images on a left display area and a right display area. Alternatively, the image control module 175 may delay or advance playback of one of the identical images output to one display area (e.g., the left display area or the right display area) by a specified time in consideration of binocular disparity.

According to various embodiments of the present disclosure, the image control module 175 may differently output a communication UI (e.g., a call-related UI or a message reception UI) for a state in which the head-mounted device 200 is connected to the electronic device 100 and a communication UI for a state in which the devices are disconnected from each other. For example, the image control module 175 may output a call-related UI to at least one display area of the display 150 in the disconnected state. In the connected state, the image control module 175 may individually output the call-related UI to the separated display areas of the display 150. In the connected state, the image control module 175 may output a virtual image related to acceptance, rejection or ending of a call. In the disconnected state, the image control module 175 may output a virtual key button related to acceptance, rejection or ending of a call.

According to various embodiments of the present disclosure, the image control module 175 may temporarily suspend output of an image when the electronic device 100 is in the dismounted state with respect to the head-mounted device 200. When the electronic device 100 is in the mounted state with respect to the head-mounted device 200, an image may be output. The image control module 175 may temporarily suspend notification of call reception or output of a call-related UI in the dismounted state of the head-mounted device 200. Alternatively, according to a setting, the image control module 175 may perform the output of the call-related UI.

Table 1 shows output of information related to call connection of an electronic device in which O represents that a particular action is performed in a particular state (i.e., mounted, connected, or disconnected), whereas an X represents that the particular is not performed in the particular state.

TABLE 1

| | | | Call-related | Virtual | |
|---|---|---|---|---|---|
| | | | UI | content | During |
| | Vibration | Ringtone | (GUI) | audio | call |
| Mounted | X | ◯ | ◯ | X | ◯ |
| Connected | ◯ | ◯ | ◯ | X | ◯ |
| Disconnected | ◯ | ◯ | X | X | ◯ |

As shown in Table 1, vibration notification may be skipped in the mounted state of the head-mounted device 200 (the head-mounted device 200 in which the electronic device 100 is inserted). Furthermore, the vibration notification may be performed in the connected state (the state in which the electronic device 100 is inserted into the slot 210 of the head-mounted device 200) and the disconnected state. Ringtone notification (output of specified audio data) may be performed by outputting audio data corresponding to a setting of the electronic device 100 in the mounted state, the connected state, or the disconnected state. In the mounted state and the connected state, the ringtone notification may be output through, for example, an earphone or a wireless headset. A call-related UI (e.g., a call reception notification image, a call reception UI, a during-a-call UI, or the like) may be output to the display 150 in the mounted state and the connected state, and may not be output in the disconnected state. An audio output of virtual content may be temporarily muted in the mounted state and the connected state, and may be skipped in the disconnected state. Audio data may be performed in any of the mounted state, the connected state, and the disconnected state during a call. In the mounted state and the connected state, during a call, audio data may be automatically set to be output through a speakerphone, or may be output through an earphone or a wireless headset corresponding to a connection type.

As described above, according to various embodiments of the present disclosure, an electronic device may include a communication interface for receiving a communication interface and a function control module configured to differently output an output interface related to the communication event (e.g., a call-related output interface or a message reception output interface) according to content (or an application) being executed.

According to various embodiments of the present disclosure, an electronic device may include a communication interface for receiving a communication event and a processor configured to check a connected state with a body-mounted device or a mounted state of the body-mounted device during a connection with the body-mounted device and differentially output an output interface related to the communication event received corresponding to the connected state or the mounted state.

According to various embodiments of the present disclosure, an electronic device according to an embodiment of the present disclosure may include a memory for storing a communication event received and a processor connected to the memory, wherein the processor may check a connected state or a mounted state of a body-mounted device and may differentially output an output interface related to the communication event received corresponding to the connected state or the mounted state.

As described above, according to various embodiments of the present disclosure, an electronic device according to an embodiment of the present disclosure may include a communication interface for receiving a communication event and a processor (or a function control module) configured to check a connected state or a mounted state of a body-mounted device and differentially output at least one output interface related to the communication event corresponding to the connected state or the mounted state.

According to various embodiments of the present disclosure, the processor (or function control module) may displays the output interface related to the communication event on each of separated display areas of a display corresponding to request to play content related to the body-mounted device.

According to various embodiments of the present disclosure, the processor (or function control module) may output a call-related screen or a message reception-related screen corresponding to the communication event on one display area if the connected state is released.

According to various embodiments of the present disclosure, in the mounted state, the processor (or function control module) may display the output interface including a call acceptance image in response to reception of the communication event, and may connect a call if the call acceptance image is gazed at for a specified time or a specified event occurs thereafter on the basis of the body-mounted device.

According to various embodiments of the present disclosure, in the mounted state, the processor (or function control module) may display the output interface including a call rejection image in response to reception of the communication event, and may reject a call if the call rejection image is gazed at for a specified time or a specified event occurs thereafter on the basis of the body-mounted device.

According to various embodiments of the present disclosure, in the mounted state, the processor (or function control module) may display the output interface including a call end image in response to reception of the communication event, and may end a call if the call end image is gazed at for a specified time or a specified event occurs thereafter on the basis of the body-mounted device.

According to various embodiments of the present disclosure, in the mounted state, the processor (or function control module) may reject or end a call if a specified portion of a content screen related to the body-mounted device is gazed at for a specified time in a call connection requested state or a during-a-call state related to the communication event.

According to various embodiments of the present disclosure, in the mounted state, the processor (or function control module) may display the output interface including a message reception notification image in response to reception of the communication event, and may display message contents if the message reception notification image is gazed at for a specified time or a specified event occurs thereafter on the basis of the body-mounted device.

According to various embodiments of the present disclosure, in the mounted state, the processor (or function control module) may display the output interface including a message reception notification image and a cancellation image in response to reception of the communication event, and may remove the message reception notification image if the cancellation image is gazed at for a specified time or a specified event occurs thereafter on the basis of the body-mounted device.

According to various embodiments of the present disclosure, in the mounted state, the processor (or function control module) may display the output interface including a message reception notification image or message contents related to the communication event, and may remove the message reception notification image or the message contents if a specified portion of a content screen related to the body-mounted device is gazed at for a specified time.

According to various embodiments of the present disclosure, in the connected state, the processor (or function control module) may output at least one of a flickering lamp light, a vibration, or audio data corresponding to call reception notification or message reception notification related to the communication event with a lamp light flickering pattern, a vibration strength level, or an audio data volume level different from that for the mounted state.

According to various embodiments of the present disclosure, the processor (or function control module) may decrease, in the mounted state, at least one of the audio data volume level or the vibration strength level so that the audio data volume level or the vibration strength level is lower than that for a dismounted state or a disconnected state.

According to various embodiments of the present disclosure, the processor (or function control module) may temporarily mute audio data of content related to the body-mounted device and may output notification audio data related to the communication event, in the connected state or the mounted state.

According to various embodiments of the present disclosure, the processor (or function control module) may gradually decrease a volume of the audio data of the content, and may gradually increase a volume of the notification audio data.

According to various embodiments of the present disclosure, the processor (or function control module) may output the audio data of the content temporarily muted with a specified volume when a call is ended.

According to various embodiments of the present disclosure, the processor (or function control module) may gradually increase a volume of the audio data of the content temporarily muted when a call is ended.

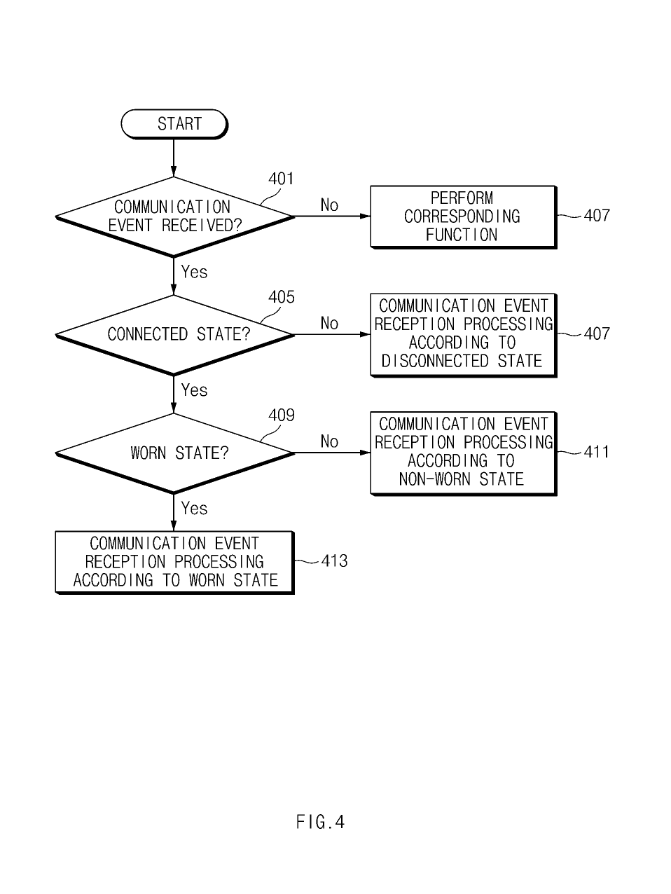

FIG. 4 illustrates a communication function control method according to various embodiments of the present disclosure.

Referring to FIG. 4, if an event occurs in operation 401, the function control module 170 may determine whether the occurrence of the event is related to reception of a communication event (e.g., a call, a text message, or the like). If the event is not reception of the communication event, in operation 403, the function control module 170 may control performance of a function corresponding to the event that has occurred. For example, the function control module 170 may support various functions including, for example, a music playback function, a video playback function, or the like corresponding to the type of the event. According to various embodiments of the present disclosure, the function control module 170 may support a function of playback of content related to the head-mounted device 200 corresponding to a state of connection to the head-mounted device 200 and a wearing state thereof.

If the communication event is received, the function control module 170 may check the state of connection to the head-mounted device 200 in operation 405. If a connection to the head-mounted device 200 is not established, the function control module 170 may perform processing of the communication event corresponding to a disconnected state in operation 407. For example, the function control module 170 may output a call reception UI or a message reception UI configured to be output to one display area to the display 150 of the electronic device 100. Alternatively, the function control module 170 may output a call reception UI including a virtual key button such as a call acceptance button or a call rejection button (e.g., a key button that supports generation of an input event corresponding to a touch input).

If the electronic device 100 is connected to the head-mounted device 200, the function control module 170 may determine whether the head-mounted device 200 is worn in operation 409. In relation to this operation, the function control module 170 may collect sensing information from the head-mounted device 200, which provides information as to whether the head-mounted device 200 is worn. According to various embodiments of the present disclosure, the function control module 170 may determine whether the head-mounted device 200 is worn or not using a sensor module included in the electronic device 100. In relation to this operation, the function control module 170 may activate one or more sensors which may include an acceleration sensor, a geomagnetic sensor, or the like of the electronic device 100, and may determine whether sensing information of a specified pattern (a specified sensing pattern related to wearing of the head-mounted device 200) is collected after the head-mounted device 200 is mounted.

If the head-mounted device 200 is not worn, the function control module 170 may perform processing of the communication event that corresponds to a non-worn state in operation 411. For example, the function control module 170 may perform a control that directs a communication event reception notification to be output through specified audio data or vibration or an LED lamp. Alternatively, the function control module 170 may transfer, to the input/output device 250 of the head-mounted device 200, audio data, vibration pattern information, LED lamp flickering information, or the like related to the communication event reception notification. In this operation, the function control module 170 may perform control so that the display 150 is turned off or outputs a specified screen (e.g., an image related to call reception notification). According to various embodiments of the present disclosure, if the head-mounted device 200 is not worn, the function control module 170 may adjust a level of volume of audio data or strength of vibration related to a communication event (e.g., call reception notification or message reception notification) to a specified first level. The specified first level may be higher than at least one of an audio data volume level or a vibration strength level for the state in which the head-mounted device 200 is worn.

If the head-mounted device 200 is worn, the function control module 170 may perform processing of the communication event that corresponds to a worn state in operation 413. For example, the function control module 170 may output a communication UI (e.g., a call reception UI or a message reception UI) configured to be output through the head-mounted device 200 to the display 150. A call reception UI related to the head-mounted device 200 may be a UI for outputting call reception notification images that are identical or have a time delay to the display area of the display 150 which is divided into two or more display areas. Alternatively, the call reception UI related to the head-mounted device 200 may include a virtual image relate to call acceptance or rejection. The virtual image may be an image that relates to performance of a function that corresponds to a touch is skipped.

According to various embodiments of the present disclosure, the function control module 170 may output audio data specified to be output in the state in which the head-mounted device 200 is worn. The audio data for the worn state may be different from audio data for the non-worn state with respect to at least one of a volume level and contents. For example, a volume level of the audio data output in the worn state may be lower than that of the audio data output in the non-worn state. According to various embodiments of the present disclosure, the function control module 170 may output, for example, at least one of a vibration or flickering lamp or light that is related to call reception notification.

The function control module 170 may perform a call connection function as a virtual image that may corresponds to a particular action pertaining to connecting the call (e.g., an acceptance image, a rejection image, or the like). In response to a particular user action, a function or action may be performed. For example, when the reception notification image is gazed at (or as a specified event occurs by a key button of the electronic device 100 or the key input device 240 after the virtual image is gazed at). For example, the function control module 170 may determine whether the user views an acceptance image or a rejection image (e.g., for a specified time) or a specified event occurs after the acceptance image or the rejection image is gazed at for a specified time on the basis of sensing information based on a movement of the head-mounted device 200 or sensing information based on detection of a view of the user. The function control module 170 may perform call connection or rejection corresponding to an image gazed at. In the case where an event related to selection of the acceptance image occurs (e.g., the image is gazed at for a specified time or a specified event occurs after the image is gazed at for a specified time), the function control module 170 may output a screen based on call connection to the display 150 (e.g., display an image on an area divided into a screen related to the head-mounted device 200).

If the rejection image is gazed at (or a specified event occurs after the image is gazed at), the function control module 170 may temporarily output a screen based on call rejection or may provide guidance via a message transmission regarding the call rejection. The function control module 170 may perform playback of virtual content. In this operation, the function control module 170 may continue to perform the playback of the virtual content when a call is received, and may temporarily suspend the playback of the virtual content when the call is connected. Alternatively, the function control module 170 may temporarily suspend playback of virtual content when a call is received, and may perform call reception notification and a following process. The function control module 170 may switch between an output of audio data based on playback of virtual content and an output of audio data based on call reception notification or call connection.

According to various embodiments of the present disclosure, the function control module 170 may output a message reception notification image or a cancellation image in the case where a message reception UI is output among one or more communication UIs. If the message reception notification image is gazed at for a specified time, the function control module 170 may output message contents in a virtual content environment. When the cancellation image is selected, the function control module 170 may remove the message reception notification image. The function control module 170 may output an end image when outputting the message contents, and may remove the message contents if the end image is gazed at for a specified time.

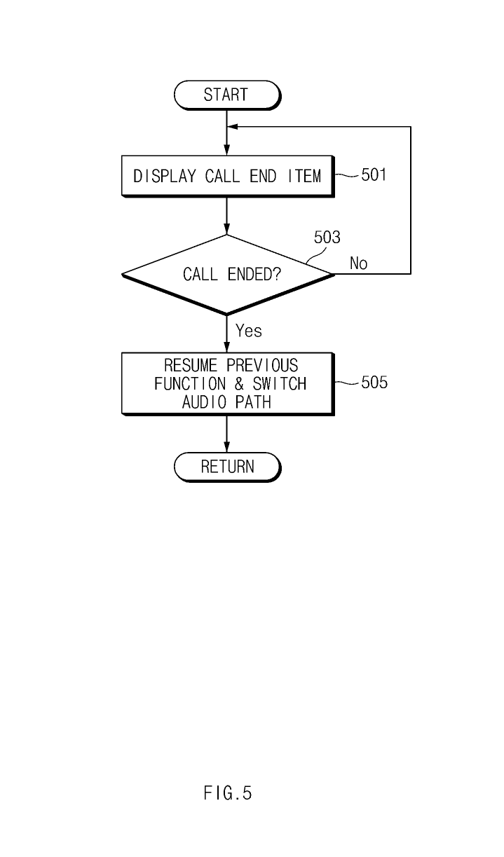

FIG. 5 illustrates a call function ending method according to various embodiments of the present disclosure.

Referring to FIG. 5, if the user is talking on a phone while wearing the head-mounted device 200, the function control module 170 may provide a during-a-call UI related to the head-mounted device 200 and including a call end item. The call end item may be a virtual image provided to end a call during the call. According to various embodiments of the present disclosure, the function control module 170 may add an item (e.g., a during-a-call time) to the during-a-call UI to output the during-a-call UI during the call.

The function control module 170 may determine whether an event related to call end occurs in operation 503. For example, the function control module 170 may determine whether an event related to the call end item (e.g., an event of moving the head-mounted device 200 or gazing at the call end item for a specified time by the user) occurs. Alternatively, the function control module 170 may receive, from the other electronic device 102, a call end event through the communication interface 160. If the event related to call end does not occur, the process may return to operation 501 so that the function control module 170 may re-perform operation 501 and the following operations.

If the event related to call end occurs, the function control module 170 may resume a function performed prior to a call function in operation 505. For example, the function control module 170 may resume virtual content executed before reception of a call. According to various embodiments of the present disclosure, the function control module 170 may output a screen displayed before reception of a call, for example, a virtual content search screen, a virtual content playback pause screen, or the like.

Furthermore, the function control module 170 may perform audio path switching. For example, the function control module 170 may deactivate an active microphone corresponding to a call connection function. Alternatively, the function control module 170 may perform output of audio data related to resumed virtual content. The process may return to a content playback operation based on the head-mounted device 200.

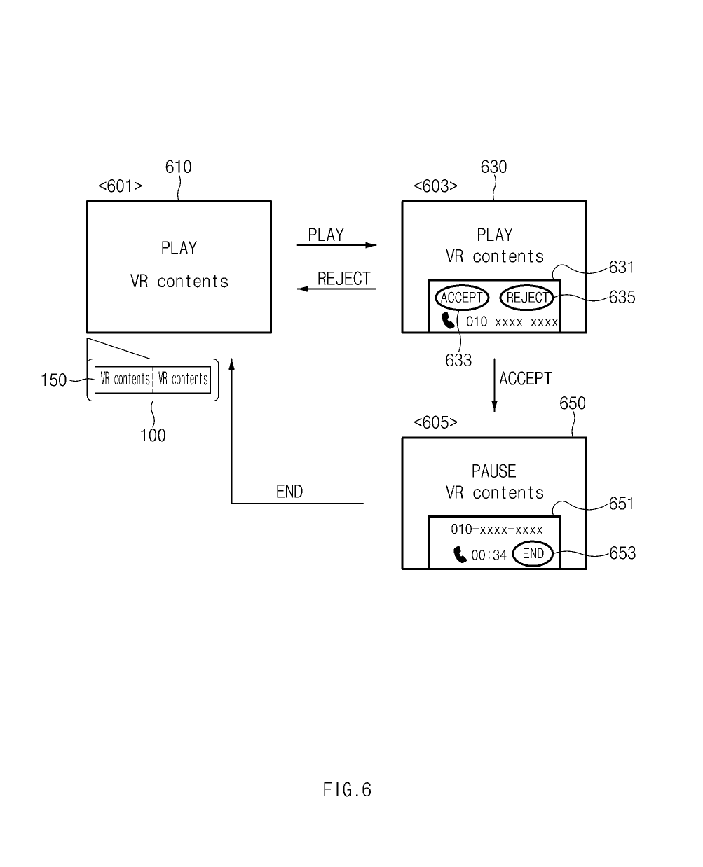

FIG. 6 is a diagram exemplarily illustrating call function processing in a device-worn state according to various embodiments of the present disclosure.

Referring to FIG. 6, as shown in a state 601, the electronic device 100 may output a virtual content screen (e.g., a virtual content home screen or a virtual content playback screen). For example, in relation to output of virtual content related to the head-mounted device 200, the electronic device 100 may divide the display area of the display 150 into, for example, two display areas, and may output identical images or a specified image and a time-delayed image to the two display areas respectively. The user may view the virtual content with a larger screen than that of the display 150 through the head-mounted device 200.

If a call is received while the virtual content is played, the electronic device 100 may output a call reception UI 631 as shown in a state 603. The call reception UI 631 may include an acceptance image 633 and a rejection image 635. Furthermore, the call reception UI 631 may output elapse time information indicating an elapse time since reception of a call. According to various embodiments of the present disclosure, the call reception UI 631 may output additional information related to reception of a call, such as identification information of another electronic device. In relation to this operation, the electronic device 100 may check phonebook information.

If an event related to selection of the acceptance image 633 included in the call reception UI 631 occurs, the electronic device 100 may output a screen in which the playback of the virtual content is temporarily suspended as shown in a state 605. For example, if an event of focusing on the acceptance image 633 occurs, or an input event related to the acceptance image 633 (e.g., an event of selecting the key input device 240 of the head-mounted device 200) occurs, the electronic device 100 may connect a call. As the call is being connected, the electronic device 100 may output a “during-a-call” UI 651. The during-a-call UI 651 may include, for example, call connection time information and an end image 653.

When the call is ended, the electronic device 100 may return to the state 601. For example, if an event related to selection of the end image 653 occurs, or an event related to ending of a call arises from another electronic device, the electronic device 100 may end a call function. The electronic device 100 may resume the playback of the virtual content after the call function is ended.

According to various embodiments of the present disclosure, the electronic device 100 may skip output of the rejection image 635 in the state 603. In relation to this operation, the electronic device 100 may reject a call if a focus of the virtual content deviates from a specified portion, for example, the call reception UI 631, or is moved to a location spaced apart from the call reception UI 631 by a certain distance. The electronic device 100 may skip output of the end image 653 in the state 605. The electronic device 100 may end a call if the focus of the virtual content is moved to a location spaced apart from the during-a-call UI 651 by a certain distance or a focus is maintained on a specified virtual content portion for a specified time.

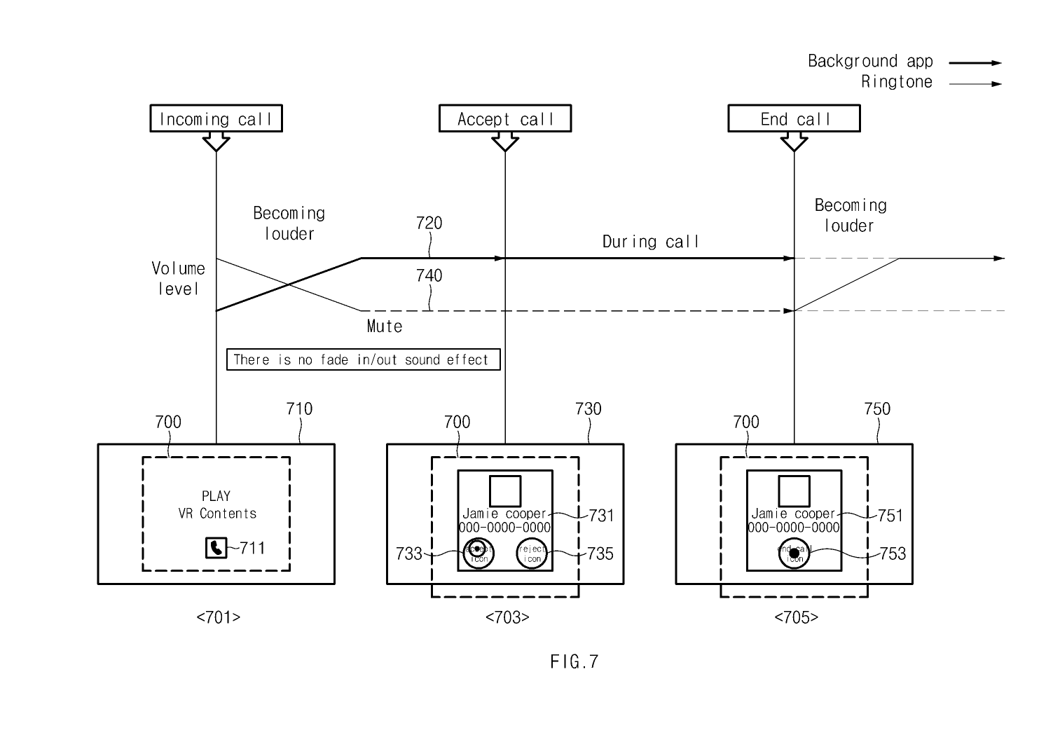

FIG. 7 illustrates audio control related to call function processing in a device-worn state according to various embodiments of the present disclosure.

Referring to FIG. 7, the electronic device 100 may output a virtual content screen 710 in a state 701. The virtual content screen 710 which is a home screen related to the head-mounted device 200. As discussed, the head-mounted the display 150 may be divided into two display areas and the same image may be displayed on each display area, and may include, for example, a screen gaze area 700. The screen gaze area 700 may be an area viewed by the user through the head-mounted device 200. As a call is received, the electronic device 100 may output, to the screen gaze area 700, a reception notification image 711 for notifying reception of the call.

Before the call is received, the electronic device 100 may output audio data based on playback of virtual content. When the call is received, the electronic device 100 may gradually decrease a volume level of the audio date related to the virtual content. The electronic device 100 may gradually increase a volume level of call reception notification audio data to a specified level. Accordingly, if a specified time elapses, the audio data related to the virtual content may be muted, and the call reception notification audio data may be output with the specified volume level.

After the reception notification image 711 is output for a specified time, the electronic device 100 may output a call reception UI 731 in a state 703. The call reception UI 731 may include an acceptance image 733 and a rejection image 735. In this operation, the electronic device 100 may perform audio path switching based on call connection. For example, the electronic device 100 may activate a microphone. Alternatively, the electronic device 100 may perform processing of audio data based on call connection (audio data transmitted from the other electronic device 100). If an event of selecting the acceptance image 733 occurs (e.g., in the case where a center point of the screen gaze area stays on the acceptance image 733 for a specified time, or a user's gaze stays on the acceptance image 733 for a specified time), the electronic device 100 may connect a call. In this operation, the electronic device 100 may remove the call reception UI 731. Furthermore, the electronic device 100 may output a during-a-call UI 751 including an end image 753.

If the end image 753 is selected or a call end event (e.g., a call disconnection request message from the other electronic device 100) is received while the during-a-call UI 751 including the end image 753 is output, the electronic device 100 may end a call in a state 705. In this state, the electronic device 100 may suspend an audio path related to call connection, and may execute an audio path based on playback of virtual content. For example, the electronic device 100 may gradually increase a volume level of audio data based on playback of virtual content from a call end time.

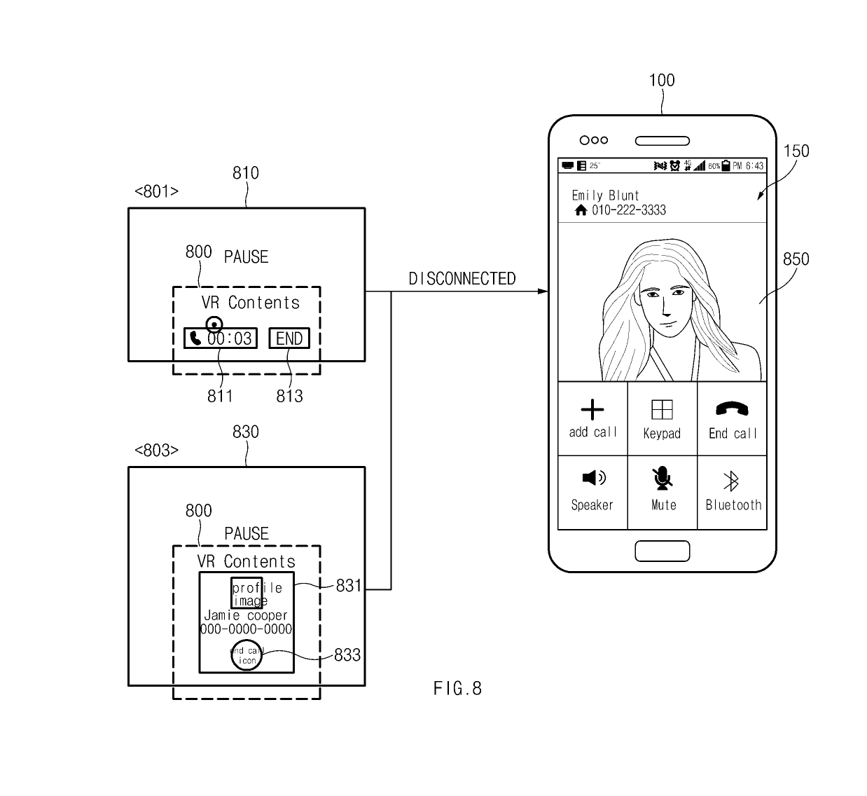

FIG. 8 is a diagram illustrating call function processing during disconnection of a device according to various embodiments of the present disclosure.

Referring to FIG. 8, if a call is connected during playback of virtual content related to the head-mounted device 200, the electronic device 100 may output a virtual content pause screen 810 as shown in a state 801. The pause screen 810 may output a during-a-call UI including a call time image 811 and an end image 813 based on call connection. When virtual content is played, a gaze area 800 may be focused on a center portion of a virtual content screen. When a call is connected, the gaze area 800 may be focused on an area where the during-a-call UI is disposed. According to various embodiments of the present disclosure, an acceptance image or the like may be output to a certain area that deviates from a center portion of a virtual content playback screen. In the case where a center (focus) of the gaze area 800 aims at the acceptance image, the electronic device 100 may change the acceptance image into the call time image 811 or the end image 813 while performing call connection. The electronic device 100 may maintain a call state if the call time image 811 is gazed at, and may end a call if the end image 813 is gazed at for a specified time or longer.

According to various embodiments of the present disclosure, if a call is connected during playback of virtual content, the electronic device 100 may output a virtual content pause screen 830 as shown in a state 803. The pause screen 830 may output a during-a-call UI 831 (including an end image 833) based on call connection. As described above, the electronic device 100 may output the acceptance image, and may output the during-a-call UI 831 if the acceptance image is focused by the gaze area 800 for a specified time or longer.

If the electronic device 100 is disconnected from the head-mounted device 200 during a call, the electronic device 100 may output a screen UI 850 based on the disconnection as shown in a state 805. The screen UI 850 may include a virtual key button that supports a touch function and an image displayed over an entire area of the display 150 of the electronic device 100.

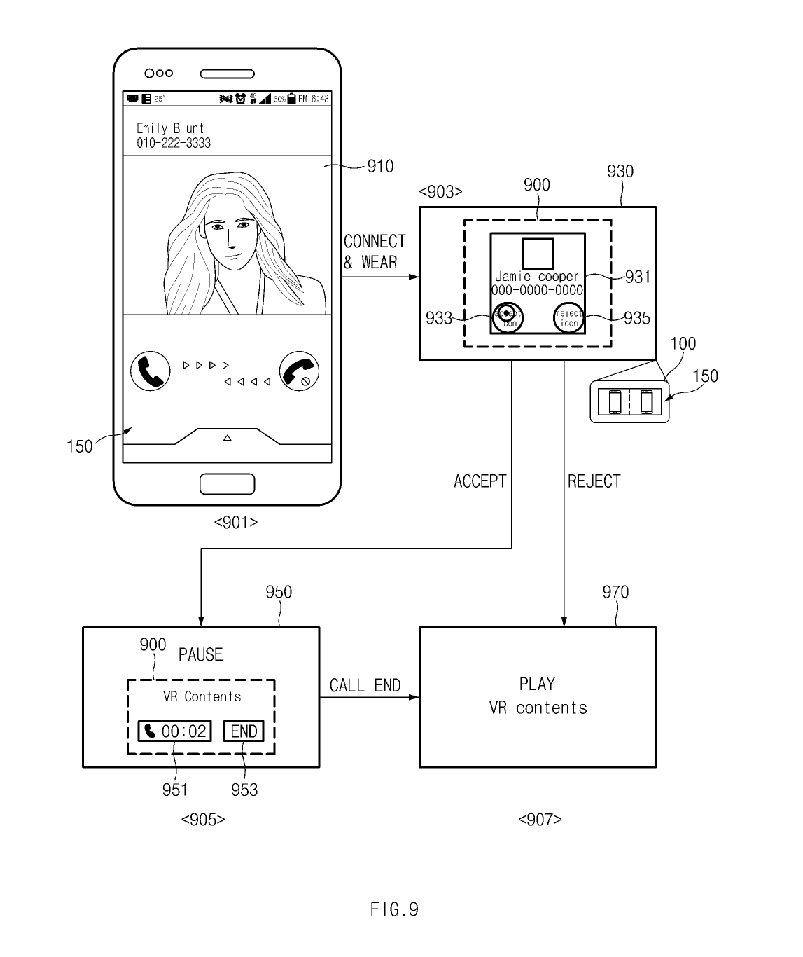

FIG. 9 is a diagram illustrating call function processing at the time of receiving a call in a state of wearing a device according to various embodiments of the present disclosure.

Referring to FIG. 9, if a call connection request message is received from another electronic device or the like, the electronic device 100 may output a screen 910 based on call reception to the display 150 in a state 901. In this operation, the electronic device 100 may output a call reception UI for a disconnected state (i.e., a state of being disconnected from the head-mounted device 200) to an entire area of the display 150 as one image.

If the electronic device 100 is connected to the head-mounted device 200 while receiving a call, the electronic device 100 may output a call reception UI 931 related to the head-mounted device 200 to a call reception screen 930 as shown in a state 903. The call reception UI 931 may include, for example, an acceptance image 933 and a rejection image 935.

The call reception UI 931, which is a UI viewed through the head-mounted device 200, may output images to two display areas of the display 150. The electronic device 100 may display a gaze area 900. Alternatively, the gaze area 900 may be an area actually viewed by the user. If a focus of the gaze area 900 stays on the acceptance image 933 for a specified time, the electronic device 100 may connect a call. If the focus of the gaze area 900 stays on the rejection image 935 for a specified time, the electronic device 100 may reject a call.

When a call is connected as the acceptance image 933 is selected, the electronic device 100 may output a virtual content pause screen 950 as shown in a state 905. The pause screen 950 may include a during-a-call UI including a call time image 951 and an end image 953. If the end image 953 is collected or a call end request message is received from the other electronic device 102, the electronic device 100 may output a virtual content playback screen as a call is ended as shown in a state 907. According to various embodiments of the present disclosure, when a call is rejected as the rejection image 935 is selected in the state 903, the electronic device 100 may output a virtual content playback screen 970 as shown in the state 907.

According to various embodiments of the present disclosure, the electronic device 100 may skip output of the end image 953. If a focus related to virtual content aims at a specified portion, or is maintained for a specified time at a portion spaced apart from the call time image 951 by a certain distance, the electronic device 100 may end a call.

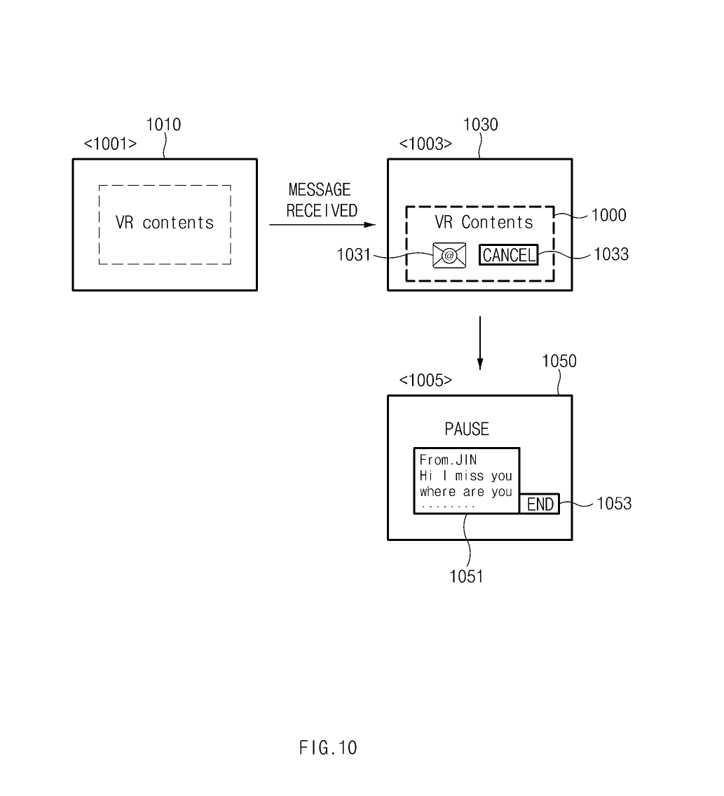

FIG. 10 is a diagram illustrating call function processing at the time of receiving a communication message according to various embodiments of the present disclosure.

Referring to FIG. 10, as shown in a state 1001, the electronic device 100 may output a virtual content screen, which may be, for example, a home screen or a virtual content playback screen related to the head-mounted device 200. For example, in relation to output of virtual content related to the head-mounted device 200, the electronic device 100 may divide the display area of the display 150 into, for example, two display areas, and may output identical images or a specified image and a time-delayed image to the two display areas respectively. The user may view the virtual content with a larger (or smaller) screen than that of the display 150 through the head-mounted device 200. The electronic device 100 may display a screen gaze area 1000. The screen gaze area 1000 may be an area of a virtual content screen, which may be viewed by the user through the head-mounted device 200.

If a call is received while the virtual content is played, the electronic device 100 may output a message reception UI including a message reception notification image 1031 and a cancellation confirmation image 1033 while outputting the virtual content as shown in a state 1003. If an event related to selection of the message reception notification image 1031 included in the message reception UI occurs, the electronic device 100 may output a screen in which the playback of the virtual content is temporarily suspended as shown in a state 1005. For example, if an event of focusing on the message reception notification image 1031 occurs, or an input event related to the message reception notification image 1031 occurs, the electronic device 100 may output message contents 1051. The electronic device 100 may output an end confirmation image 1053 together with the message contents 1051.

According to various embodiments of the present disclosure, the electronic device 100 may skip output of the cancellation confirmation image 1033 or the end confirmation image 1053. In relation to this operation, the electronic device 100 may remove the message reception notification image 1031 or may end displaying of the message contents 1051 if a focused portion is located at a specified area. For example, the specified area may be an area that deviates from a virtual content screen or is spaced apart from the message reception notification image 1031 or the message contents 1051 by a certain distance.

An input event related to the message reception notification image 1031 may include, for example, an event of selecting the key input device 240 of the head-mounted device 200 or an event of selecting the key input device 240 while the message reception notification image 1031 on the screen gaze area 1000 is gazed at. If the message reception notification image 1031 is gazed at for a specified time by the screen gaze area 1000, the electronic device 100 may output an indicator (e.g., a mark) that indicates a gaze state (or a specified state) onto the message reception notification image 1031 or an area adjacent thereto. If an event related to the end confirmation image 1053 or an event of selecting the cancellation image 1033 of the state 1003 occurs, the electronic device 100 may return to the state 1001.

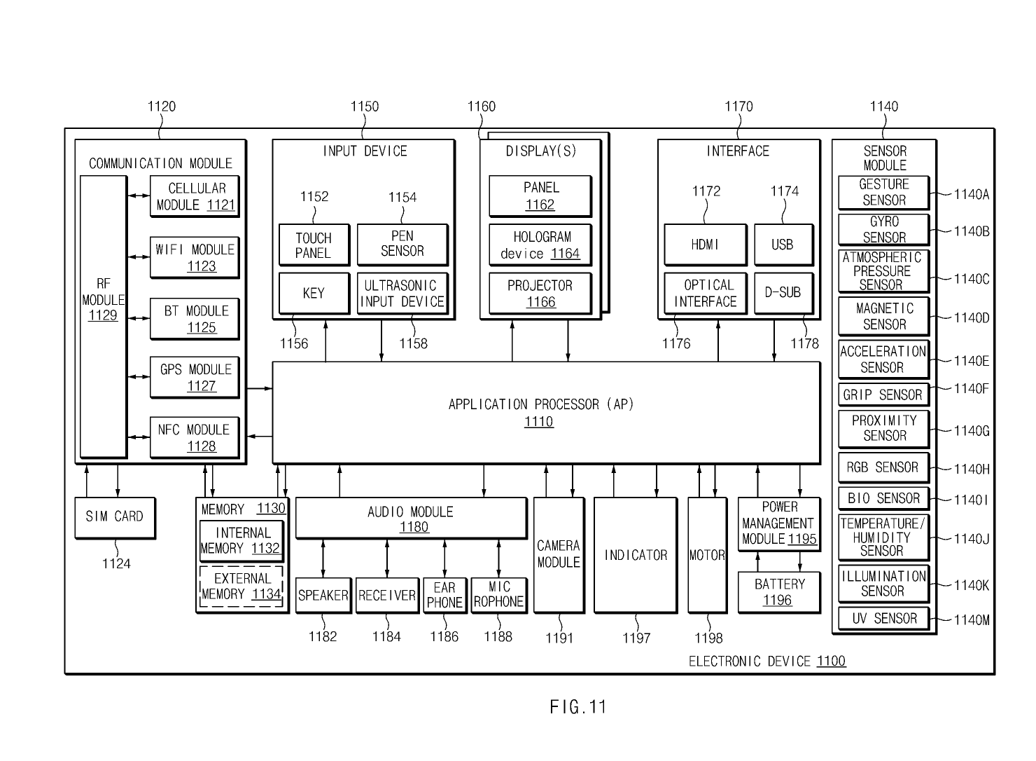

FIG. 11 is a diagram of an example of an electronic device 1100 according to various embodiments of the present disclosure.

Referring to FIG. 11, an electronic device 1100 may include one or more application processors (AP) 1110, a communication module 1120, a subscriber identification module (SIM) card 1124, a memory 1130, a sensor module 1140, an input device 1150, a display 1160, an interface 1170, an audio module 1180, a camera module 1191, a power management module 1195, a battery 1196, an indicator 1197, and a motor 1198.

The AP 1110 may drive an operating system (OS) or an application to control a plurality of hardware or software components connected to the AP 1110 and may process and compute a variety of data including multimedia data. The AP 1110 may be implemented with a System on Chip (SoC), for example. According to an embodiment of the present disclosure, the AP 1110 may further include a graphic processing unit (GPU) (not illustrated).

The communication module 1120 may transmit and receive data when there are conveyed communications between other electronic devices connected with the electronic device through a network. According to an embodiment of the present disclosure, the communication module 1120 may include a cellular module 1121, a wireless-fidelity (Wi-Fi) module 1123, a Bluetooth (BT) module 1125, a global positioning system (GPS) module 1127, a near field communication (NFC) module 1128, and a radio frequency (RF) module 1129.

The cellular module 1121 may provide voice communication, video communication, a character service, an Internet service or the like through a communication network (e.g., an LTE, an LTE-A, a CDMA, a WCDMA, a UMTS, a WiBro, a GSM, or the like). Also, the cellular module 1121 may perform discrimination and authentication of an electronic device within a communication network using a subscriber identification module (e.g., a SIM card 1124), for example. According to an embodiment of the present disclosure, the cellular module 1121 may perform at least a portion of functions that the AP 1110 provides. For example, the cellular module 1121 may perform at least a portion of a multimedia control function.

According to an embodiment of the present disclosure, the cellular module 1121 may include a communication processor (CP). Also, the cellular module 1121 may be implemented with, for example, a SoC. Although components such as the cellular module 1121 (e.g., a communication processor), the memory 1130, the power management module 1195, and the like are illustrated as being components independent of the AP 1110, the AP 1110 may be implemented to include at least a portion (e.g., a cellular module 1121) of the above components.

According to an embodiment of the present disclosure, the AP 1110 or the cellular module 1121 (e.g., a communication processor) may load and process an instruction or data received from nonvolatile memories respectively connected thereto or from at least one of other elements at the nonvolatile memory. Also, the AP 1110 or the cellular module 1121 may store data received from at least one of other elements or generated by at least one of other elements at a nonvolatile memory.

Each of the Wi-Fi module 1123, the BT module 1125, the GPS module 1127, and the NFC module 1128 may include a processor for processing data exchanged through a corresponding module, for example. In FIG. 11, an embodiment of the present disclosure is exemplified as the cellular module 1121, the Wi-Fi module 1123, the BT module 1125, the GPS module 1127, and the NFC module 1128 are separate blocks, respectively. According to an embodiment of the present disclosure, at least a portion (e.g., two or more components) of the cellular module 1121, the Wi-Fi module 1123, the BT module 1125, the GPS module 1127, and the NFC module 1128 may be included within one Integrated Circuit (IC) or an IC package. For example, at least a portion (e.g., a communication processor corresponding to the cellular module 1121 and a Wi-Fi processor corresponding to the Wi-Fi module 1123) of communication processors corresponding to the cellular module 1121, the Wi-Fi module 1123, the BT module 1125, the GPS module 1127, and the NFC module 1128 may be implemented with one SoC.

The RF module 1129 may transmit and receive data, for example, an RF signal. Although not illustrated, the RF module 1129 may include a transceiver, a power amplifier module (PAM), a frequency filter, or low noise amplifier (LNA). Also, the RF module 1129 may further include the following part for transmitting and receiving an electromagnetic wave in a space in wireless communication: a conductor or a conducting wire. In FIG. 11, an embodiment of the present disclosure is exemplified as the cellular module 1121, the Wi-Fi module 1123, the BT module 1125, the GPS module 1127, and the NFC module 1128 are implemented to share one RF module 1129. According to an embodiment of the present disclosure, at least one of the cellular module 1121, the Wi-Fi module 1123, the BT module 1125, the GPS module 1127, or the NFC module 1128 may transmit and receive an RF signal through a separate RF module.

The SIM card 1124 may be a card that includes a subscriber identification module and may be inserted into a slot formed at a specific position of the electronic device. The SIM card 1124 may include one or more unique identifiers (e.g., integrated circuit card identifier (ICCID)) or subscriber information (e.g., integrated mobile subscriber identity (IMSI)).

The memory 1130 may include an embedded memory 1132 or an external memory 1134. For example, the embedded memory 1132 may include at least one of a volatile memory (e.g., a dynamic random access memory (DRAM), a static RAM (SRAM), or a synchronous DRAM (SDRAM)) and a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory).

According to an embodiment of the present disclosure, the internal memory 1132 may be a solid state drive (SSD). The external memory 1134 may include a flash drive, for example, compact flash (CF), secure digital (SD), micro secure digital (Micro-SD), mini secure digital (Mini-SD), extreme digital (xD) or a memory stick. According to an embodiment of the present disclosure, the electronic device 1100 may further include a storage device (or a storage medium), such as a hard drive.

The sensor module 1140 may measure a physical quantity or may detect an operation state of the electronic device 1100. The sensor module 1140 may convert the measured or detected information to an electric signal. The sensor module 1140 may include at least one of a gesture sensor 1140A, a gyro sensor 1140B, a pressure sensor 1140C, a magnetic sensor 1140D, an acceleration sensor 1140E, a grip sensor 1140F, a proximity sensor 1140G, a color sensor 1140H (e.g., red, green, blue (RGB) sensor), a living body sensor 1140I, a temperature/humidity sensor 1140J, an illuminance sensor 1140K, or an UV sensor 1140M. Although not illustrated, additionally or generally, the sensor module 1140 may further include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 1140 may further include a control circuit for controlling at least one or more sensors included therein.

The input device 1150 may include a touch panel 1152, a (digital) pen sensor 1154, a key 1156, or an ultrasonic input unit 1158. The touch panel 1152 may recognize a touch input using at least one of capacitive, resistive, infrared and ultrasonic detecting methods. Also, the touch panel 1152 may further include a control circuit. In the case of using the capacitive detecting method, a physical contact recognition or proximity recognition may be allowed. The touch panel 1152 may further include a tactile layer. In this case, the touch panel 1152 may provide a tactile reaction to a user.

The (digital) pen sensor 1154 may be implemented in a similar or same manner as the method of receiving a touch input from a user or may be implemented using an additional sheet for recognition. The key 1156 may include, for example, a physical button, an optical key, a keypad, and the like. The ultrasonic input device 1158, which is an input device for generating an ultrasonic signal, may enable the electronic device 1100 to detect a sound wave through a microphone (e.g., a microphone 1188) so as to identify data, wherein the ultrasonic input device 1158 is capable of wireless recognition. According to an embodiment the present disclosure, the electronic device 1100 may use the communication module 1120 so as to receive a user input from an external device (e.g., a computer or server) connected to the communication module 1120.

The display 1160 may include a panel 1162, a hologram device 1164, or a projector 1166. The panel 1162 may be, for example, a liquid crystal display (LCD), an active matrix organic light-emitting diode (AM-OLED, or the like. The panel 1162 may be, for example, flexible, transparent or wearable. The panel 1162 and the touch panel 1152 may be integrated into a single module. The hologram device 1164 may display a stereoscopic image in a space using a light interference phenomenon. The projector 1166 may project light onto a screen so as to display an image. The screen may be arranged in the inside or the outside of the electronic device 1100. According to an embodiment of the present disclosure, the display 1160 may further include a control circuit for controlling the panel 1162, the hologram device 1164, or the projector 1166.

The interface 1170 may include, for example, an HDMI (high-definition multimedia interface) 1172, a USB (universal serial bus) 1174, an optical interface 1176, or a D-sub (D-subminiature) 1178. The interface 1170 may include, for example, a communications interface. Additionally or alternatively, the interface 1170 may include, for example, a mobile high definition link (MHL) interface, a SD card/multi-media card (MMC) interface, or an infrared data association (IrDA) standard interface.

The audio module 1180 may convert a sound and an electric signal in dual directions. At least a portion of the audio module 1180 may be included, for example, in an input/output interface. The audio module 1180 may process, for example, sound information that is input or output through a speaker 1182, a receiver 1184, an earphone 1186, or a microphone 1188.

According to an embodiment of the present disclosure, the camera module 1191 for shooting a still image or a video may include at least one image sensor (e.g., a front sensor or a rear sensor), a lens (not illustrated), an image signal processor (ISP, not illustrated), or a flash (e.g., an LED or a xenon lamp, not illustrated).

The power management module 1195 may manage the power supply of the electronic device 1100. Although not illustrated, a power management integrated circuit (PMIC) a charger IC, or a battery or fuel gauge may be included in the power management module 1195.

The PMIC may be mounted on an integrated circuit or a SoC semiconductor. A charging method may be classified into a wired charging method and a wireless charging method. The charger IC may charge a battery, and may prevent an overvoltage or an overcurrent from being introduced from a charger. According to an embodiment of the present disclosure, the charger IC may include a charger IC for at least one of the wired charging method and the wireless charging method. The wireless charging method may include, for example, a magnetic resonance method, a magnetic induction method or an electromagnetic method, and may include an additional circuit, for example, a coil loop, a resonant circuit, or a rectifier, and the like.

The battery gauge may measure, for example, a remaining capacity of the battery 1196 and a voltage, current or temperature thereof while the battery is charged. The battery 1196 may store or generate electricity, and may supply power to the electronic device 1100 using the stored or generated electricity. The battery 1196 may include, for example, a rechargeable battery or a solar battery.

The indicator 1197 may display a specific state of the electronic device 1100 or a portion thereof (e.g., the AP 1110), such as a booting state, a message state, a charging state, and the like. The motor 1198 may convert an electrical signal into a mechanical vibration. Although not illustrated, a processing device (e.g., a GPU) for supporting a mobile TV may be included in the electronic device 1100. The processing device for supporting a mobile TV may process media data according to the standards of DMB, digital video broadcasting (DVB) or media

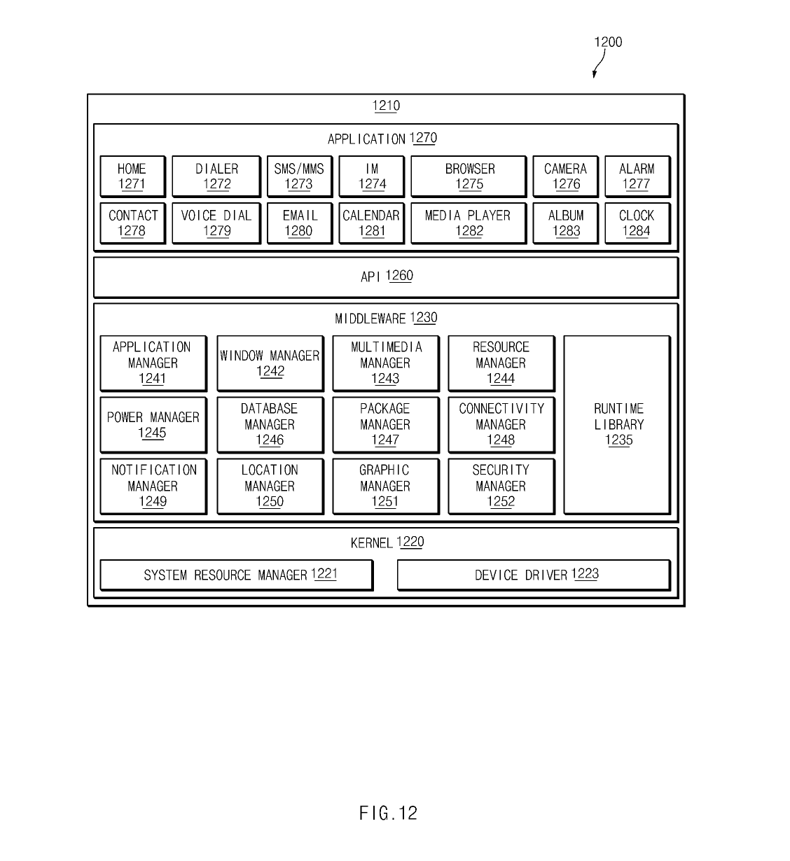

FIG. 12 is a block diagram illustrating a program module according to various embodiments of the present disclosure.

Referring to FIG. 12, according to an embodiment of the present disclosure, the program module 1210 may include an operating system (OS) for controlling a resource relating to an electronic device and/or various applications running on the OS. The OS, for example, may include android, iOS, windows, symbian, tizen, or bada.

The program module 1210 may include an OS and an application 1270. The OS may include a kernel 1220, a middleware 1230, and an API 1260. At least part of the program module 1210 may be preloaded on an electronic device or may be downloaded from a server.

The kernel 1220, for example, may include a system resource manager 1221 or a device driver 1223. The system resource manager 1221 may perform the control, allocation, or retrieval of a system resource. According to an embodiment of the disclosure, the system resource manager 1221 may include a process management unit, a memory management unit, or a file system management unit. The device driver 1223, for example, may include a display driver, a camera driver, a Bluetooth driver, a sharing memory driver, a USB driver, a keypad driver, a WiFi driver, an audio driver, or an inter-process communication (IPC) driver.

The middleware 1230, for example, may provide a function that the application 1270 requires commonly, or may provide various functions to the application 1270 through the API 1260 in order to allow the application 1270 to efficiently use a limited system resource inside the electronic device. According to an embodiment of the disclosure, the middleware 1230 may include at least one of a runtime library 1235, an application manager 1241, a window manager 1242, a multimedia manager 1243, a resource manager 1244, a power manager 1245, a database manager 1246, a package manager 1247, a connectivity manager 1248, a notification manager 1249, a location manager 1250, a graphic manager 1251, and a security manager 1252.

The runtime library 1235, for example, may include a library module that a complier uses to add a new function through a programming language while the application 1270 is running. The runtime library 1235 may perform a function on input/output management, memory management, or an arithmetic function.

The application manager 1241, for example, may mange the life cycle of at least one application among the applications 1270. The window manager 1242 may manage a GUI resource used in a screen. The multimedia manager 1243 may recognize a format for playing various media files and may encode or decode a media file by using the codec corresponding to a corresponding format. The resource manager 1244 may manage a resource such as a source code, a memory, or a storage space of at least any one of the applications 1270.

The power manager 1245, for example, may operate together with a basic input/output system (BIOS) to manage the battery or power and may provide power information necessary for an operation of the electronic device. The database manager 1246 may create, search, or modify a database used in at least one application among the applications 1270. The package manager 1247 may manage the installation or update of an application distributed in a package file format.

The connectivity manger 1248 may manage a wireless connection such as WiFi or Bluetooth. The notification manager 1249 may display or notify an event such as arrival messages, appointments, and proximity alerts. The location manager 1250 may manage location information on an electronic device. The graphic manager 1251 may manage a graphic effect to be provided to a user or a user interface relating thereto. The security manager 1252 may provide various security functions necessary for system security or user authentication. According to an embodiment of the present disclosure, when an electronic device includes a phone function, the middleware 1230 may further include a telephony manager for managing a voice or video call function of the electronic device.

The middleware 1230 may include a middleware module for forming a combination of various functions of the above-mentioned components. The middleware 1230 may provide a module specialized for each type of OS to provide differentiated functions. Additionally, the middleware 1230 may delete part of existing components or add new components dynamically.

The API 1260, for example, as a set of API programming functions, may be provided as another configuration according to OS. For example, in the case of android or iOS, one API set may be provided for each platform and in the case Tizen, at least two API sets may be provided for each platform.

The application 1270 may include at least one application for providing functions such as a home 1271, a dialer 1272, an SMS/MMS 1273, an instant message 1274, a browser 1275, a camera 1276, an alarm 1277, a contact 1278, a voice dial 1279, an e-mail 1280, a calendar 1281, a media player 1282, an album 1283, a clock 1284, health care (for example, measure an exercise amount or blood sugar), or environmental information provision (for example, provide air pressure, humidity, or temperature information).

According to an embodiment of the disclosure, the application 1270 may include an application (hereinafter referred to as “information exchange application”) for supporting information exchange between the electronic device and an external electronic device. The information exchange application, for example, may include a notification relay application for relaying specific information to the external device or a device management application for managing the external electronic device.

For example, the notification relay application may have a function for relaying to an external electronic device notification information occurring from another application (for example, an SMS/MMS application, an e-mail application, a health care application, or an environmental information application) of the electronic device. Additionally, the notification relay application may receive notification information from an external electronic device and may then provide the received notification information to a user. The device management application, for example, may manage (for example, install, delete, or update) at least one function (turn-on/turn off of the external electronic device itself (or some components) or the brightness (or resolution) adjustment of a display) of an external electronic device communicating with the electronic device, an application operating in the external electronic device, or a service (for example, call service or message service) provided from the external device.

According to an embodiment of the disclosure, the application 1270 may include a specific application (for example, a health care application) according to the property (for example, as the property of an electronic device, when the type of the electronic device is a mobile medical device) of the external electronic device. According to an embodiment of the present disclosure, the application 1270 may include an application received from an external electronic device. According to an embodiment of the disclosure, the application 1270 may include a preloaded application or a third party application downloadable from a server. The names of components in the program module 1210 according to the shown embodiment may vary depending on the type of OS.

According to various embodiments of the present disclosure, at least part of the program module 1210 may be implemented with software, firmware, hardware, or a combination thereof. At least part of the programming module 1210, for example, may be implemented (for example, executed) by a processor (for example, the AP 1210). At least part of the programming module 1210 may include a module, a program, a routine, sets of instructions, or a process to perform at least one function, for example.

As described above, according to various embodiments of the present disclosure, a communication function control method according to an embodiment of the present disclosure may include receiving a communication event and differently outputting an output interface related to the communication event according to content being executed.

As described above, according to various embodiments of the present disclosure, a communication function control method according to an embodiment of the present disclosure may include receiving a communication event, checking a connected state with a body-mounted device or a mounted state of the body-mounted device during a connection with the body-mounted device and differentially outputting an output interface related to the communication event corresponding to the connected state or the mounted state.

According to various embodiments of the present disclosure, the outputting may include any of displaying the output interface related to the communication event on each of separated display areas of a display corresponding to request to play content related to the body-mounted device, the output interface related to the communication event on each of separated display areas of a display when content related to the body-mounted device is played and outputting a message reception-related screen, or a call-related screen based on the communication event to one display area if the connected state is released.

According to various embodiments of the present disclosure, the outputting may include at least one of: displaying, in the mounted state, the output interface including a call acceptance image based on reception of the communication event and performing call connection if the call acceptance image is gazed at for a specified time or a specified event occurs thereafter on the basis of the body-mounted device; displaying, in the mounted state, the output interface including a call rejection image based on the reception of the communication event and performing call rejection if the call rejection image is gazed at for a specified time or a specified event occurs thereafter on the basis of the body-mounted device; displaying, in the mounted state, the output interface including a call end image based on the reception of the communication event and performing call ending if the call end image is gazed at for a specified time or a specified event occurs thereafter on the basis of the body-mounted device; performing, in the mounted state, the call rejection or the call ending if a specified portion of a content screen related to the body-mounted device is gazed at for a specified time in a call connection requested state or a during-a-call state related to the communication event; displaying, in the mounted state, the output interface including a message reception notification image based on the reception of the communication event and displaying message contents if the message reception notification image is gazed at for a specified time or a specified event occurs thereafter on the basis of the body-mounted device; displaying, in the mounted state, the output interface including the message reception notification image and a cancellation image based on the reception of the communication event and removing the message reception notification image if the cancellation image is gazed at for a specified time or a specified event occurs thereafter on the basis of the body-mounted device; and displaying, in the mounted state, the output interface including the message reception notification image or message contents related to the communication event and removing the message reception notification image or the message contents if a specified portion of the content screen related to the body-mounted device is gazed at for a specified time.

According to various embodiments of the present disclosure, the outputting may include outputting, in the connected state, at least one of a flickering lamp light, a vibration, or audio data corresponding to call reception notification or message reception notification related to the communication event with a lamp light flickering pattern, a vibration level, or an audio data volume level different from that for the mounted state.

According to various embodiments of the present disclosure, the outputting may include at least one of: outputting, in the mounted state, at least one of audio data or a vibration with a volume level or a vibration strength level lower than that for a dismounted state or a disconnected state; muting, in the connected state or the mounted state, audio data of the content related to the body-mounted device and outputting notification audio data related to the communication event; gradually decreasing a volume level of the audio data of the content and gradually increasing a volume level of the notification audio data; outputting the muted audio data of the content with a specified volume level when a call is ended; and gradually increasing the volume level of the muted audio data of the content as the call is ended.

According to various embodiments of the present disclosure, at least a part of the program module may be implemented with software, firmware, hardware, or a combination thereof. At least a part of the program module, for example, may be implemented (e.g., executed) by a processor (e.g., an AP). At least a part of the program module may include, for example, a module, program, routine, sets of instructions, or process for performing at least one function.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a programming module. In the case where the instructions are performed by a processor (e.g., the processor 120), the processor may perform functions corresponding to the instructions. The computer-readable storage medium may be any suitable type of volatile and non-volatile memory.

The computer-readable recording medium may include a hard disk, a floppy disk, a magnetic medium (e.g., a magnetic tape), an optical medium (e.g., CD-ROM, DVD), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

According to various embodiments of the present disclosure, a computer-readable recording medium stores at least one instruction executable by at least one processor, wherein the instruction may be configured to perform receiving a communication event (e.g., call reception or message reception) and differently outputting an output interface of the communication event according to content (or an application) being executed.

According to various embodiments of the present disclosure, a computer-readable recording medium stores at least one instruction executable by at least one processor, wherein the instruction may be configured to perform receiving a communication event (e.g., call reception or message reception) and differently outputting an output interface of the communication event corresponding to a connected state or a mounted state of a head-mounted device.

The module or program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

According to various embodiments of the present disclosure, a communication function of an electronic device, such as call reception or message reception, may be such provided that the user may easily handle the communication function even while an operation based on a body-mounted device is performed.

The above embodiments of the present disclosure are illustrative and not limitative. Various alternatives and equivalents are possible. Other additions, subtractions, or modifications are obvious in view of the present disclosure and are intended to fall within the scope of the appended claims.

What is claimed is:

1. An electronic device comprising:
a communication interface for receiving a communication event; and
at least one processor configured to determine a state of a body-mounted device with respect to the electronic device, the state including at least one of a connected state of the body-mounted device with respect to the electronic device and a mounted state of the body-mounted device with respect to the electronic device, wherein the least one processor is configured to differentially output an output interface related to the communication event received corresponding to the determination of at least one of the connected state and the mounted state.

2. The electronic device of claim 1, wherein the least one processor is configured to display the output interface related to the communication event, wherein the output interface is displayed on each of the separated display areas while playing content related to the body-mounted device on the display.

3. The electronic device of claim 2, wherein the least one processor outputs at least one of a call-related screen and a message reception-related screen corresponding to the communication event on one display area if the connected state ceases.

4. The electronic device of claim 1, wherein, in the mounted state, the least one processor displays the output interface including a call acceptance image in response to reception of the communication event, and connects a call if the call acceptance image is gazed at for a specified time or a specified event occurs thereafter.

5. The electronic device of claim 1, wherein, in the mounted state, the least one processor displays the output interface including a call rejection image in response to reception of the communication event and rejects a call if the call rejection image is gazed at for a specified time or a specified event occurs thereafter.

6. The electronic device of claim 1, wherein, in the mounted state, the least one processor displays the output interface including a call end image in response to reception of the communication event and ends a call if the call end image is gazed at for a specified time or a specified event occurs thereafter.

7. The electronic device of claim 1, wherein, in the mounted state, the least one processor rejects or ends a call if a specified portion of a content screen related to the body-mounted device is gazed at for a specified time in a call connection requested state or a during-a-call state related to the communication event.

8. The electronic device of claim 1, wherein, in the mounted state, the least one processor displays the output interface including a message reception notification image in response to reception of the communication event and displays message contents if the message reception notification image is gazed at for a specified time or a specified event occurs thereafter.

9. The electronic device of claim 1, wherein, in the mounted state, the least one processor displays the output interface including a message reception notification image and a cancellation image in response to reception of the communication event, and removes the message reception notification image if the cancellation image is gazed at for a specified time or a specified event occurs thereafter.

10. The electronic device of claim 1, wherein, in the mounted state, the least one processor displays the output interface including a message reception notification image or message contents related to the communication event, and removes the message reception notification image or the message contents if a specified portion of a content screen related to the body-mounted device is gazed at for a specified time.

11. The electronic device of claim 1, wherein, in the connected state, the least one processor outputs at least one of a flickering lamp light, a vibration, or audio data corresponding to call reception notification or message reception notification related to the communication event with a lamp light flickering pattern, a vibration strength level, or an audio data volume level different from that for the mounted state.

12. The electronic device of claim 11, wherein the least one processor decreases, in the mounted state, at least one of the audio data volume level or the vibration strength level so that the audio data volume level or the vibration strength level is lower than that for a dismounted state or a disconnected state.

13. The electronic device of claim 1, wherein the least one processor temporarily mutes audio data of content related to the body-mounted device and outputs notification audio data related to the communication event, in the connected state or the mounted state.

14. The electronic device of claim 13, wherein the least one processor gradually decreases a volume of the audio data of the content, and gradually increases a volume of the notification audio data.

15. The electronic device of claim 13, wherein the least one processor outputs the audio data of the content temporarily muted with a specified volume when a call is ended.

16. The electronic device of claim 13, wherein the least one processor gradually increases a volume of the audio data of the content temporarily muted when a call is ended.

17. A communication function control method comprising:
receiving a communication event;
determining a state of a body-mounted device with respect to an electronic device, the state including at least one of a connected state with a body-mounted device and a mounted state of the body-mounted device during a connection with the body-mounted device; and
differentially outputting an output interface related to the communication event, the communication event corresponding to at least one of the connected state and the mounted state.

18. The communication function control method of claim 17, wherein the outputting comprises displaying the output interface related to the communication event on each of separated display areas of a display corresponding to request to play content related to the body-mounted device.

19. The communication function control method of claim 18, wherein the outputting comprises outputting a call-related screen or a message reception-related screen corresponding to the communication event on one display area if the connected state is released.

20. The communication function control method of claim 17, wherein the outputting comprises at least one of:
displaying, in the mounted state, the output interface including a call acceptance image based on reception of the communication event and performing call connection if the call acceptance image is gazed at for a specified time or a specified event occurs thereafter;
displaying, in the mounted state, the output interface including a call rejection image based on the reception of the communication event and performing call rejection if the call rejection image is gazed at for a specified time or a specified event occurs thereafter;
displaying, in the mounted state, the output interface including a call end image based on the reception of the communication event and performing call ending if the call end image is gazed at for a specified time or a specified event occurs thereafter;
performing, in the mounted state, the call rejection or the call ending if a specified portion of a content screen related to the body-mounted device is gazed at for a specified time in a call connection requested state or a during-a-call state related to the communication event;
displaying, in the mounted state, the output interface including a message reception notification image based on the reception of the communication event and displaying message contents if the message reception notification image is gazed at for a specified time or a specified event occurs thereafter;
displaying, in the mounted state, the output interface including the message reception notification image and a cancellation image based on the reception of the communication event and removing the message reception notification image if the cancellation image is gazed at for a specified time or a specified event occurs thereafter; and
displaying, in the mounted state, the output interface including the message reception notification image or message contents related to the communication event and removing the message reception notification image or the message contents if a specified portion of the content screen related to the body-mounted device is gazed at for a specified time.
